(19) United States
(12) Patent Application Publication
(10) Pub. No.: US 2026/0244655 A1
(43) Pub. Date: Aug. 20, 2026

(54) ANSWER SUPPORT APPARATUS, ANSWER SUPPORT METHOD, AND RECORDING MEDIUM

(71) Applicant: NEC Corporation, Tokyo (JP)

(72) Inventor: Takeru Nagano, Tokyo (JP)

(73) Assignee: NEC Corporation, Tokyo (JP)

(21) Appl. No.: 19/453,430

(22) Filed: Jan. 20, 2026

(30) Foreign Application Priority Data
Feb. 14, 2025 (JP) 2025-022137

(51) Int. Cl. G06F 16/3329

(52) U.S. Cl. CPC G06F 16/33295

(57) ABSTRACT

An answer support apparatus includes one or more memories storing instructions and one or more processors configured to execute the instructions to: transmit a user question to pieces of generative AI and receiving generated answers, calculate a matching rate of the generated answers by the pieces of the generative AI, in a case where the matching rate is equal to or more than a matching rate threshold value, create an output answer, create the output answer in a case where there are the generated answers having the reliability that is equal to or more than the reliability threshold value, create the output answer for requesting the user to change the user question in a case where there is no generated answer having the reliability that is equal to or more than the reliability threshold value, and output the output answer.

### RELATED APPLICATION

This application is based upon and claims the benefit of priority from Japanese Patent Application No. 2025-022137, filed on Feb. 14, 2025, the disclosure of which is incorporated herein in its entirety by reference.

### TECHNICAL FIELD

The present disclosure relates to an answer support apparatus, an answer support method, and a recording medium.

### BACKGROUND ART

JP 7488617 B1 describes a program that inputs a question sentence received from a user as input data into a large-scale language model, thereby acquiring a determination result regarding whether the question sentence is appropriate as input data for a question answer system that can output an answer sentence.

### SUMMARY

An example of the object of the present disclosure is to provide an answer support apparatus or the like capable of easily determining appropriateness of an answer generated by generative AI.

According to an aspect of the present disclosure, an answer support apparatus includes question reception means for receiving a user question by a user, answer request means for transmitting the user question to a plurality of pieces of generative AI and receiving generated answers generated for the user question from a plurality of pieces of the generative AI, matching rate calculation means for calculating a matching rate of the generated answers by the plurality of pieces of the generative AI, answer creation means for creating an output answer based on the generated answers by the plurality of pieces of generative AI in a case where the matching rate is equal to or more than a matching rate threshold value, output means for outputting the output answer, and mutual evaluation means for, in a case where the matching rate is lower than the matching rate threshold value, requesting a different generative AI different from the plurality of pieces of the generative AI that has generated the generated answer among the plurality of pieces of the generative AI for evaluation for each of a plurality of the generated answers, and calculating reliability based on an evaluation result, in which the answer creation means creates the output answer based on the generated answer having the reliability that is equal to or more than a reliability threshold value in a case where there are the generated answers having the reliability that is equal to or more than the reliability threshold value, and creates the output answer for requesting the user to change the user question in a case where there is no generated answer having the reliability that is equal to or more than the reliability threshold value.

According to another aspect of the present disclosure, an answer support method includes receiving a user question by a user, transmitting the user question to a plurality of pieces of generative AI and receiving generated answers generated for the user question from a plurality of pieces of the generative AI, calculating a matching rate of the generated answers by the plurality of pieces of the generative AI, in a case where the matching rate is lower than a matching rate threshold value, requesting a different generative AI different from the plurality of pieces of the generative AI that has generated the generated answer among the plurality of pieces of the generative AI for evaluation for each of a plurality of the generated answers, and calculating reliability based on an evaluation result, creating an output answer based on the generated answer having the reliability that is equal to or more than a reliability threshold value in a case where there are the generated answers having the reliability that is equal to or more than the reliability threshold value, creating the output answer for requesting the user to change the user question in a case where there is no generated answer having the reliability that is equal to or more than the reliability threshold value, creating the output answer based on the generated answers by a plurality of pieces of the generative AI in a case where the matching rate is equal to or more than the matching rate threshold value, and outputting the output answer.

According to still another aspect of the present disclosure, a program causes a computer to execute processing including receiving a user question by a user, transmitting the user question to a plurality of pieces of generative AI and receiving generated answers generated for the user question from a plurality of pieces of the generative AI, calculating a matching rate of the generated answers by the plurality of pieces of the generative AI, in a case where the matching rate is lower than a matching rate threshold value, requesting a different generative AI different from the plurality of pieces of the generative AI that has generated the generated answer among the plurality of pieces of the generative AI for evaluation for each of a plurality of the generated answers, and calculating reliability based on an evaluation result, creating an output answer based on the generated answer having the reliability that is equal to or more than a reliability threshold value in a case where there are the generated answers having the reliability that is equal to or more than the reliability threshold value, creating the output answer for requesting the user to change the user question in a case where there is no generated answer having the reliability that is equal to or more than the reliability threshold value, creating the output answer based on the generated answers by a plurality of pieces of the generative AI in a case where the matching rate is equal to or more than the matching rate threshold value, and outputting the output answer.

The program may be stored in a non-transitory computer-readable recording medium.

### BRIEF DESCRIPTION OF THE DRAWINGS

FIG. 1 is a diagram illustrating an example of a configuration of a system including an answer support apparatus;

FIG. 2 is a block diagram illustrating an example of a configuration of the answer support apparatus;

FIG. 3 is a diagram illustrating an example of a screen for inputting a user question;

FIG. 4 is a first explanatory diagram illustrating an example of exchange between the answer support apparatus and generative AI;

FIG. 5 is a second explanatory diagram illustrating an example of exchange between the answer support apparatus and the generative AI;

FIG. 6 is a third explanatory diagram illustrating an example of exchange between the answer support apparatus and the generative AI;

FIG. 7 is a fourth explanatory diagram illustrating an example of exchange between the answer support apparatus and the generative AI;

FIG. 8 is an explanatory diagram illustrating an example of a method of calculating reliability of each generated answer;

FIG. 9 is a first diagram illustrating an example of a screen on which an output answer is displayed;

FIG. 10 is a second diagram illustrating an example of a screen on which an output answer is displayed;

FIG. 11 is a third diagram illustrating an example of a screen on which an output answer is displayed;

FIG. 12A is a first flowchart illustrating an operation of the answer support apparatus;

FIG. 12B is a second flowchart illustrating the operation of the answer support apparatus;

FIG. 13 is a block diagram illustrating an example of a configuration of an answer support apparatus;

FIG. 14 is a first diagram illustrating an example of a screen on which an output answer including an alternative question is displayed;

FIG. 15 is a second diagram illustrating an example of a screen on which an output answer including an alternative question is displayed;

FIG. 16A is a third flowchart illustrating an operation of the answer support apparatus;

FIG. 16B is a fourth flowchart illustrating the operation of the answer support apparatus; and

FIG. 17 is a diagram illustrating an example of a hardware configuration of the answer support apparatus.

### EXAMPLE EMBODIMENT

Hereinafter, example embodiments of the present disclosure will be described in detail with reference to the drawings.

### First Example Embodiment

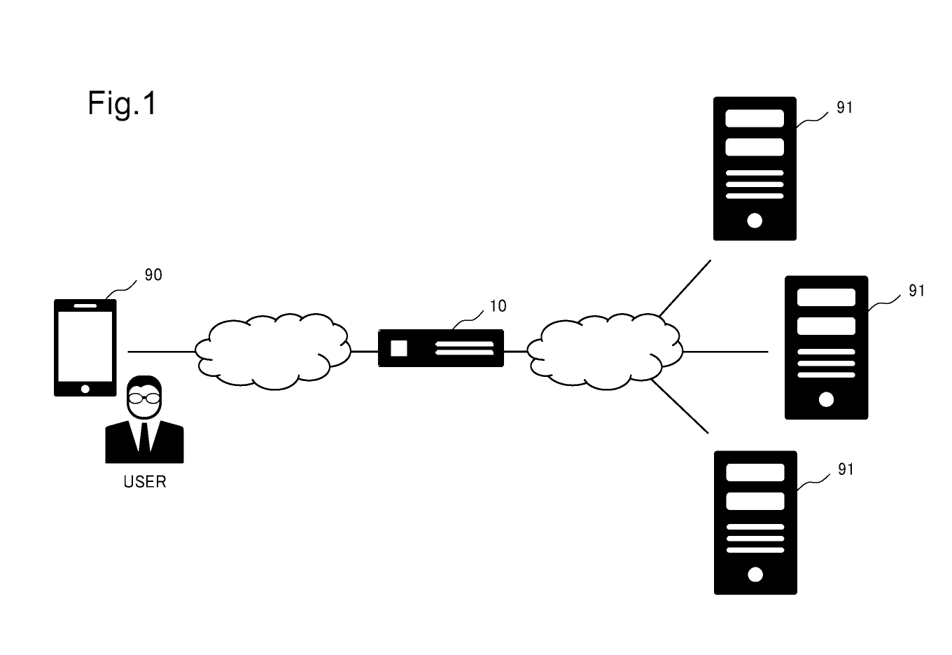

A configuration example of an answer support system including an answer support apparatus 10 will be described with reference to FIG. 1. FIG. 1 is a diagram illustrating an example of a configuration of the answer support system including the answer support apparatus. The answer support system includes the answer support apparatus 10, a user terminal 90, and a generation server 91. The answer support apparatus 10 is connected to the user terminal 90 via a wired or wireless network. The answer support apparatus 10 is connected to each generation server 91 via a wired or wireless network.

The user terminal 90 is a terminal used by a user. First, the user is a person who asks a question to generative AI. The user asks a question to the generative AI in order to obtain an answer from the generative AI. The user terminal 90 is a terminal used in a case where the user transmits a question to the generative AI. The user can input a question to the user terminal 90. Examples of the user terminal 90 include a smartphone, a tablet terminal, and a personal computer. The user terminal 90 is not limited to these. In the example illustrated in FIG. 1, the answer support apparatus 10 is connected to one user terminal 90. The number of user terminals 90 to which the answer support apparatus 10 is connected is not limited to this. The answer support apparatus 10 can be connected to a plurality of user terminals 90. At this time, the answer support apparatus 10 may be connected to user terminals 90 of a plurality of users. The answer support apparatus 10 may be connected to a plurality of user terminals 90 used by one user.

The generation server 91 is a server equipped with the generative AI. The generative AI is sentence generative AI capable of generating a sentence. Examples of generative AI include ChatGPT(registered trademark), Google Gemini, and Microsoft Copilot. The generative AI is not limited to these, and may be any sentence generative AI used for sentence generation. The generation server 91 is equipped with different types of generative AI. The answer support apparatus 10 is connected to a plurality of generation servers 91. In the example illustrated in FIG. 1, the answer support apparatus 10 is connected to three generation servers 91. The three generation servers 91 are each equipped with different generative AI. The number of the generation servers 91 to which the answer support apparatus 10 is connected is not limited to this. The answer support apparatus 10 is connected to a plurality of generation servers 91. Here, one generation server 91 may be equipped with a plurality of pieces of generative AI. In this case, the answer support apparatus 10 may be connected to one generation server 91. That is, the answer support apparatus 10 may be connected to the generation server 91 so long as a plurality of pieces of generative AI can be used.

Hereinafter, a case where the answer support apparatus 10 is connected to three generation servers 91 will be described as an example. The generation servers 91 are a generation server 91a, a generation server 91b, and a generation server 91c. Each generation server 91 is equipped with different generative AI. Pieces of generative AI are assumed to be generative AIa, generative AIb, and generative AIc, respectively.

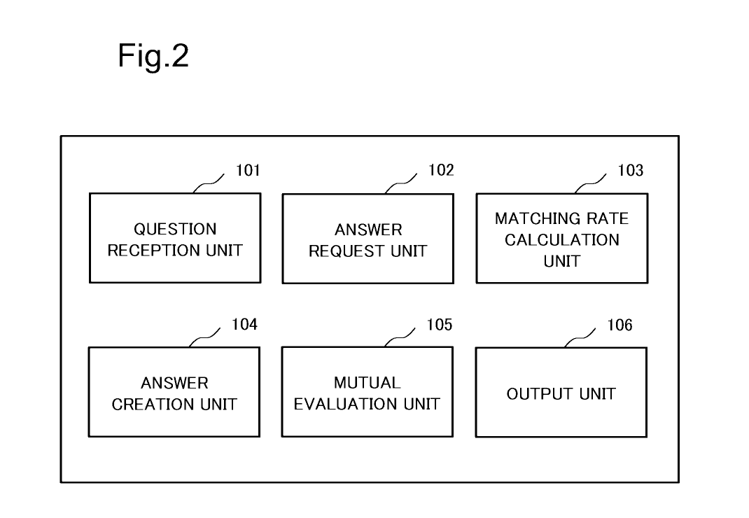

A configuration of the answer support apparatus 10 will be described with reference to FIG. 2. FIG. 2 is a block diagram illustrating an example of the configuration of the answer support apparatus. The answer support apparatus 10 includes a question reception unit 101, an answer request unit 102, a matching rate calculation unit 103, an answer creation unit 104, a mutual evaluation unit 105, and an output unit 106.

The question reception unit 101 is an aspect of question reception means for receiving a user question by a user. The user asks a question to the generative AI. At this time, for example, the user inputs a question to the user terminal 90. In the following description, a question asked to the generative AI by the user is referred to as a user question. The user terminal 90 transmits the input question to the question reception unit 101. The question reception unit 101 can receive a user question from the user terminal 90. The question reception unit 101 can receive a user question by receiving the user question from the user terminal 90.

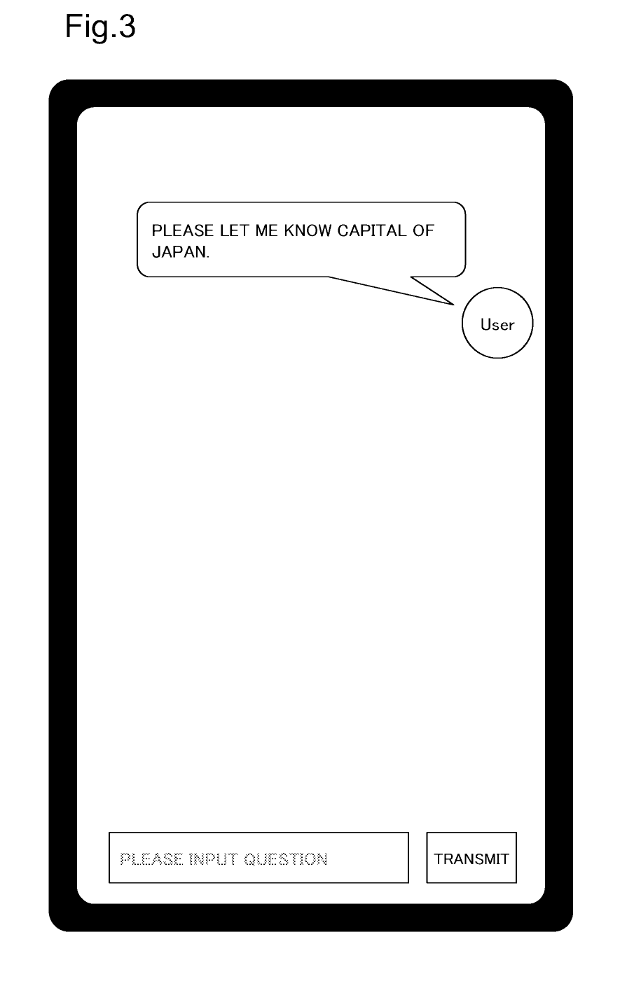

An example of a screen of the user terminal 90 to which a user question has been input will be described with reference to FIG. 3. FIG. 3 is a diagram illustrating an example of a screen for inputting a user question. As in the example illustrated in FIG. 3, the user can input a user question on the user terminal 90. In FIG. 3, the user question is displayed in a chat form. First, the user inputs a question in a text box. The user can transmit a question input in the text box by pressing the “transmit” button. The transmitted question is displayed in a balloon on the screen of the user terminal 90. The question reception unit 101 can receive a question transmitted by the user as a user question. A display form in the user terminal 90 is not limited to this. An operation method by the user using the user terminal 90 is not limited to this.

The answer request unit 102 is an aspect of answer request means for transmitting a user question to a plurality of pieces of generative AI and receiving a generated answer generated for the user question from a plurality of pieces of the generative AI. The answer request unit 102 transmits the user question received by the question reception unit 101 to a plurality of generation servers 91. The answer request unit 102 can transmit the user question to a plurality of pieces of generative AI. Each piece of generative AI receives the user question from the answer request unit 102. Each piece of generative AI generates an answer to the user question. The answer to the user question, which has been generated by the generative AI, is referred to as a generated answer. Each piece of generative AI outputs the generated answer to the answer request unit 102. The answer request unit 102 receives the generated answer from the plurality of pieces of generative AI.

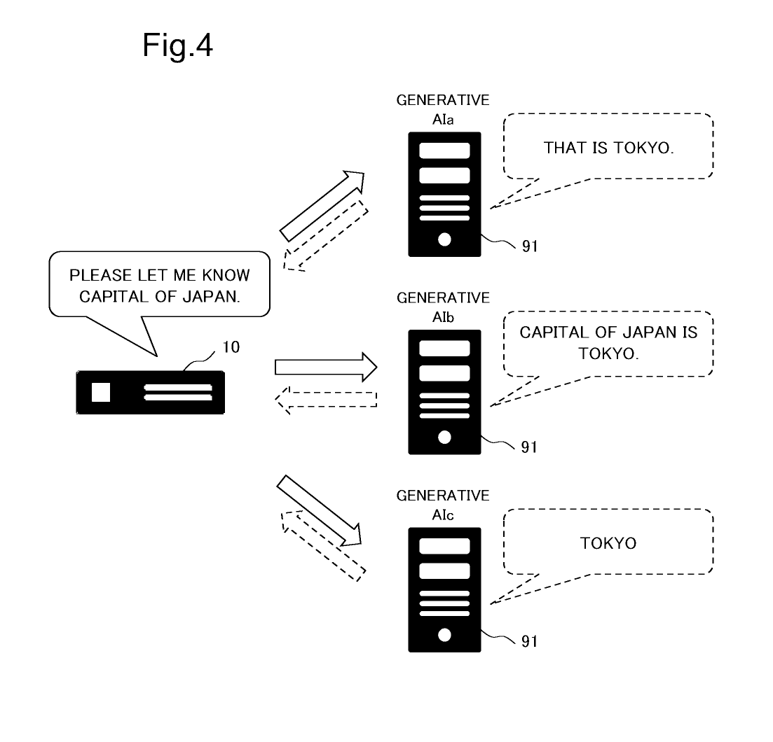

The exchange between the answer support apparatus 10 and each piece of generative AI will be described with reference to FIG. 4. FIG. 4 is a first explanatory diagram illustrating an example of exchange between the answer support apparatus and the generative AI. For example, the answer request unit 102 transmits a user question to each of the generative AIa, the generative AIb, and the generative AIc. Each of the generative AIa, the generative AIb, and the generative AIc generates an answer to the user question. Each of the generative AIa, the generative AIb, and the generative AIc outputs a generated answer to the answer request unit 102. The answer request unit 102 receives an answer to the user question from each of the generative AIa, the generative AIb, and the generative AIc. Here, answers generated by the generative AIa, the generative AIb, and the generative AIc are referred to as a generated answer a, a generated answer b, and a generated answer c, respectively. The answer request unit 102 can receive the generated answer a, the generated answer b, and the generated answer c.

The matching rate calculation unit 103 is an aspect of matching rate calculation means for calculating a matching rate of generated answers by a plurality of pieces of generative AI. The matching rate calculation unit 103 calculates the matching rate of the generated answers that have been respectively generated by the plurality of pieces of generative AI and received by the answer request unit 102. The matching rate is a rate at which the content of the generated answer is common. Matching of the generated answers means that the contents of the generated answers are the same, and it is not necessary that the words of the generated answers themselves match with each other.

The matching rate calculation unit 103 calculates a matching rate of generated answers generated by a plurality of pieces of generative AI. For example, in a case where the generative AIa, the generative AIb, and the generative AIc generate the generated answer a, the generated answer b, and the generated answer c, respectively, the matching rate calculation unit 103 calculates the matching rate between the generated answer a, the generated answer b, and the generated answer c.

The matching rate calculation unit 103 calculates the matching rate by using a known method of comparing sentence distributed expressions. For example, the matching rate calculation unit 103 calculates the matching rate of the generated answers by using a TF-IDF method, an SCDV method, or WRD. The method of calculating the matching rate is not limited to these.

The matching rate calculation unit 103 compares the calculated matching rate with a matching rate threshold value. The matching rate threshold value is a threshold value for determining the level of the matching rate of the generated answer. The matching rate threshold value can be set to any value. The matching rate threshold value may be set by a user, for example. The matching rate threshold value is a value used to determine the correctness of the generated answer. The matching rate threshold value is a value with a high possibility that the content of the generated answer is correct, in a case where the matching rate exceeds the matching rate threshold value. The answer creation unit 104 which will be described next creates an output answer according to a comparison result between the calculated matching rate and the matching rate threshold value.

The answer creation unit 104 is an aspect of answer creating means for creating an output answer based on the generated answers by the plurality of pieces of generative AI in a case where the matching rate is equal to or more than the matching rate threshold value. The matching rate calculation unit 103 compares the matching rate with the matching rate threshold value. In a case where the matching rate is equal to or more than the matching rate threshold value, the answer creation unit 104 creates an output answer based on the generated answers by the plurality of pieces of the generative AI. Here, the matching rate is a rate at which the content of the generated answer is common as described above. In a case where a rate of matching between the contents of the generated answers by all the pieces of generative AI is high, there is a high possibility that the contents of the generated answers are correct. In a case where the rate of matching between the contents of the generated answers by all the pieces of generative AI is high, there is a high possibility that the content of the generated answer is appropriate. An example of an appropriate answer is an answer having a correct content. Therefore, in a case where the matching rate is equal to or more than the matching rate threshold value, the answer creation unit 104 creates an output answer by using a plurality of generated answers.

The answer creation unit 104 creates an output answer by using all the generated answers generated by the plurality of pieces of generative AI. A case of a high matching rate means a case where the rate at which the contents of the generated answers by the plurality of pieces of generative AI are common is high. That is, there is a high possibility that the contents of the generated answers by the plurality of pieces of generative AI are appropriate answers. Therefore, the answer creation unit 104 creates, for example, a summary of all the generated answers as the output answer. The output answer is an answer output to the user who has asked the question to the generative AI. The output of the output answer will be described later.

The answer creation unit 104 creates an output answer by using a known natural language generation technique. The matching rate calculation unit 103 calculates the matching rate for each clause, for example, by using the method of comparing sentence distributed expressions. Therefore, the answer creation unit 104 can create a summary of all the generated answers as the output answer with reference to a clause having a high matching rate. The method of creating the output answer by the answer creation unit 104 is not limited to this.

The answer creation unit 104 creates an output answer also in a case where the matching rate is lower than the matching rate threshold value. At this time, the content and the creation method of the output answer created by the answer creation unit 104 will be described later.

The mutual evaluation unit 105 is an aspect of mutual evaluation means for, in a case where the matching rate is lower than the matching rate threshold value, requesting generative AI different from the generative AI that has generated the generated answer among the plurality of pieces of generative AI for evaluation for each of the plurality of generated answers, and calculating reliability based on an evaluation result. The matching rate calculation unit 103 compares the matching rate with a matching rate threshold value. A case where the matching rate is lower than the matching rate threshold value means a case where each piece of generative AI generates a generated answer having different contents. In a case where each piece of generative AI generates a generated answer having different contents, there is a case where it is not possible to output an appropriate answer to the user.

The case where each piece of generative AI generates the generated answer having different contents includes a case where some pieces of generative AI do not generate a correct answer and a case where there may be a plurality of correct answers to the user question. In a case where the generative AI has not generated a correct answer to the user question, that is, in a case where the generative AI has generated a wrong answer to the user question, it can be said that the answer is not an appropriate answer. In a case where there may be a plurality of correct answers to the user question, a plurality of answers may include, for example, an answer different from the answer required by the user. For example, each generated answer is not an incorrect answer to the user question, but may include an answer that is different from the answer required by the user. In this case, it may be difficult to output an appropriate answer to the user. The answer required by the user is not limited to the answer clearly required by the user. For example, in a case where the user wants to know the meaning of a certain word in a specific field, but the meaning in a different field is answered by the generative AI, it can be said that the answer is not the answer required by the user. On the other hand, in a case where the meaning of a word in the specific field that the user has wanted to know is answered by the generative AI, it can be said that the answer is the answer required by the user. As described above, the answer required by the user is, for example, an answer according to the intention of the question of the user.

Therefore, the mutual evaluation unit 105 requests another generative AI to evaluate each generated answer. The mutual evaluation unit 105 requests another generative AI to evaluate whether each generated answer is a correct answer. For example, the mutual evaluation unit 105 checks whether another generative AI agrees for each generated answer. In addition, the mutual evaluation unit 105 may question whether each generated answer is correct, to another generative AI. The specific content of the question to the another generative AI is not limited to this. Here, the another generative AI refers to generative AI different from the generative AI that has generated the generated answer as an evaluation target.

In a case where the matching rate is lower than the matching rate threshold value, the mutual evaluation unit 105 requests evaluation by another generative AI for each of generated answers by a plurality of pieces of generative AI. The mutual evaluation unit 105 requests another generative AI to evaluate whether each generated answer is a correct answer. When the evaluation is requested, for example, a question as to whether to agree with a generated answer of certain generative AI is transmitted to another generative AI. The another generative AI receives a question as to whether the generative AI agrees with the generated answer as a target of mutual evaluation. The another generative AI outputs an answer as to whether the generative AI agrees with the generated answer as a target of the mutual evaluation. The mutual evaluation unit 105 receives an answer as to whether to agree with the generated answer as the target of the mutual evaluation from the another generative AI.

The mutual evaluation unit 105 may question whether each generated answer is correct, to another generative AI. At this time, the mutual evaluation unit 105 transmits a question as to whether the generated answer of certain generative AI is correct to another generative AI. The another generative AI receives a question as to whether the generated answer as the target of the mutual evaluation is correct. The another generative AI outputs an answer as to whether the generated answer as the target of the mutual evaluation is correct. The mutual evaluation unit 105 receives, from the another generative AI, an answer as to whether the generated answer as the target of the mutual evaluation is correct.

The following description will be made on the assumption that the mutual evaluation unit 105 checks whether another generative AI agrees for a certain generated answer.

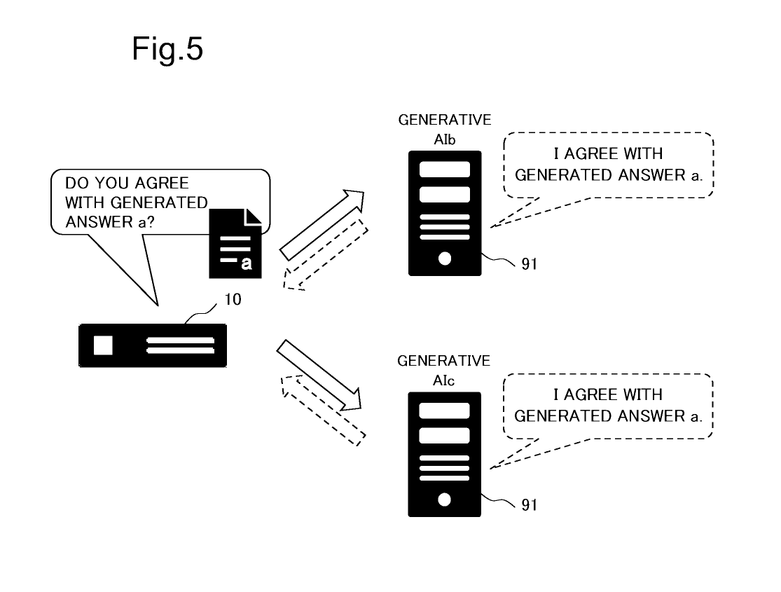

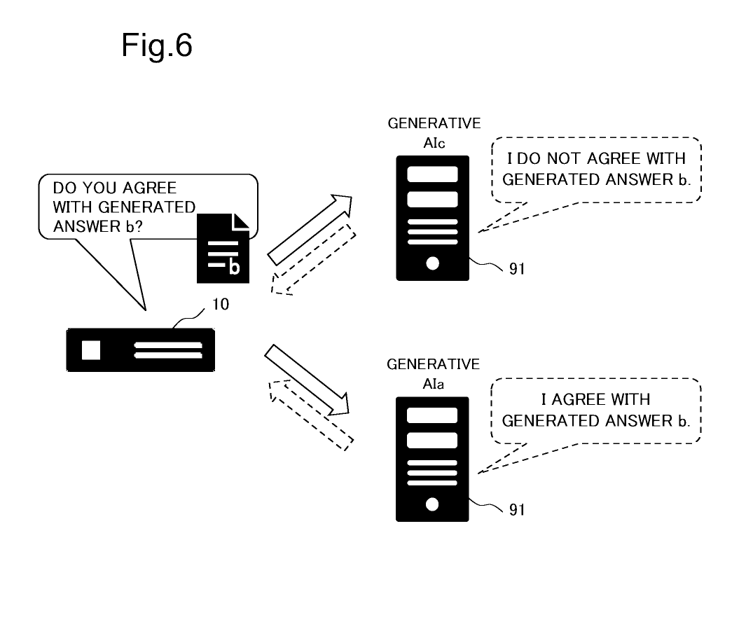

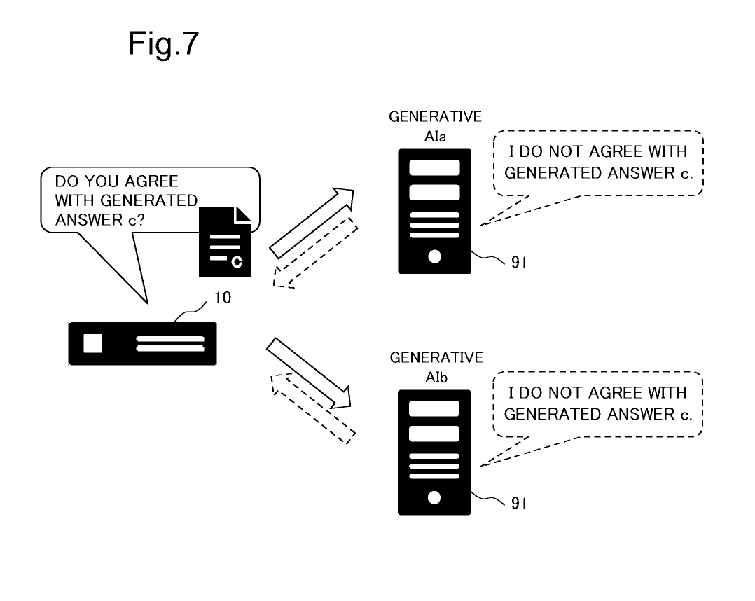

With reference to FIGS. 5 to 7, mutual evaluation by the mutual evaluation unit 105 will be described. In FIGS. 5 to 7, a case where the generative AIa, the generative AIb, and the generative AIc are used will be described as an example. FIG. 5 is a second explanatory diagram illustrating an example of exchange between the answer support apparatus and the generative AI. FIG. 6 is a third explanatory diagram illustrating an example of exchange between the answer support apparatus and the generative AI. FIG. 7 is a fourth explanatory diagram illustrating an example of exchange between the answer support apparatus and the generative AI.

As illustrated in the example in FIG. 5, the mutual evaluation unit 105 asks, to the generative AIb and the generative AIc, a question as to whether the generative AIb and the generative AIc agree with the generated answer a generated by the generative AIa. The generative AIb and the generative AIc each output an answer as to whether to agree with the generated answer a to the mutual evaluation unit 105. The mutual evaluation unit 105 can receive an answer as to whether to agree with the generated answer a from the generative AIb and the generative AIc.

As illustrated in the example in FIG. 6, similarly for the generated answer b, the mutual evaluation unit 105 asks, to the generative AIc and the generative AIa, a question as to whether the generative AIc and the generative AIa agree with the generated answer b generated by the generative AIb. The generative AIc and the generative AIa each output an answer as to whether to agree with the generated answer b to the mutual evaluation unit 105. The mutual evaluation unit 105 can receive an answer as to whether to agree with the generated answer b from the generative AIc and the generative AIa.

As illustrated in the example in FIG. 7, similarly for the generated answer c, the mutual evaluation unit 105 asks, to the generative AIa and the generative AIb, a question as to whether the generative AIa and the generative AIb agree with the generated answer c generated by the generative AIc. The generative AIa and the generative AIb each output an answer as to whether to agree with the generated answer c to the mutual evaluation unit 105. The mutual evaluation unit 105 can receive an answer as to whether to agree with the generated answer c from the generative AIa and the generative AIb.

As described above, the mutual evaluation unit 105 asks a question as to whether the generative AI different from the generative AI that has generated the generated answer agrees, for all the generated answers received by the answer request unit 102. A question as to whether to agree with the generated answer generated by the generative AI other than the corresponding generative AI is transmitted to one generative AI.

The mutual evaluation unit 105 calculates the reliability based on the evaluation result. The reliability is calculated for each generated answer. The reliability is a ratio at which other pieces of generative AI evaluate that each generated answer is correct. That is, the reliability of each generated answer is a ratio at which the generated answer is evaluated to be correct by other pieces of generative AI. For example, the reliability is a ratio at which, for each generated answer, the generative AI other than the generative AI that has generated the generated answer has agreed. The reliability may be a ratio at which each generated answer is answered as being correct by the generative AI other than the generative AI that has generated the generated answer. The reliability of a certain generated answer is the number obtained by dividing the number of pieces of generative AI that have evaluated that the generated answer is correct, by the number of pieces of generative AI requested to evaluate the generated answer. The reliability is represented by a percentage, for example.

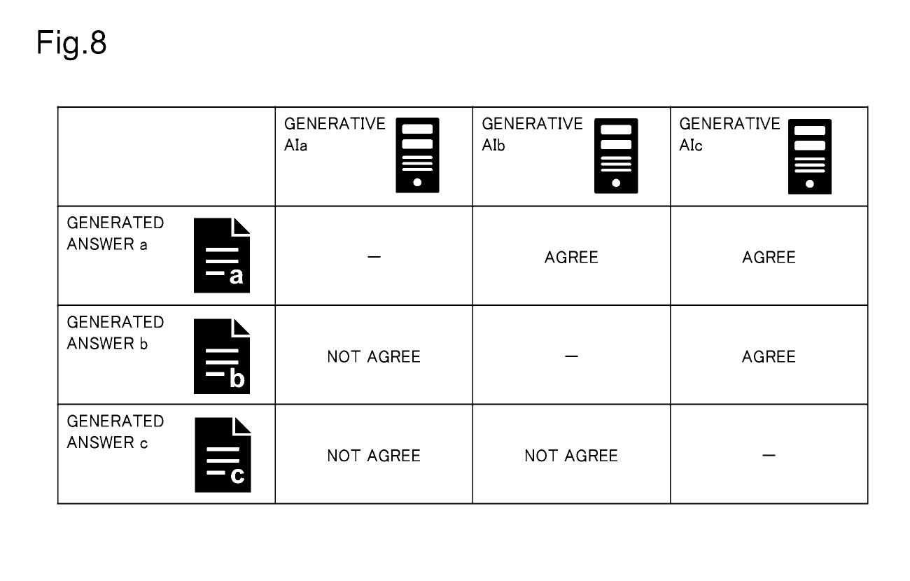

The calculation of the reliability will be described with reference to FIG. 8. FIG. 8 is an explanatory diagram illustrating an example of a method of calculating reliability of each generated answer. In FIG. 8, a case where the generative AIa, the generative AIb, and the generative AIc are used will be described as an example. In the example illustrated in FIG. 8, targets of the mutual evaluation are the generated answer a, the generated answer b, and the generated answer c. For each generated answer, check results of the generative AIa, the generative AIb, and the generative AIc are illustrated. For the generated answer a, the generative AIb agrees and the generative AIc agrees. For the generated answer b, the generative AIc does not agree, and the generative AIa agrees. For the generated answer c, the generative AIa does not agree, and the generative AIb does not agree. For the combination of the generated answer and the generative AI for which the mutual evaluation is not performed, “-” is described in the frame of the table.

The mutual evaluation unit 105 calculates the reliability of each generated answer based on the evaluation result. In the example illustrated in FIG. 8, the reliability of the generated answer a is calculated to be 100%. The reliability of the generated answer b is calculated to be 50%, and the reliability of the generated answer c is calculated to be 0%.

The mutual evaluation unit 105 compares the calculated reliability with a reliability threshold value. The reliability threshold value is a threshold value for determining whether the generated answer is a correct answer. As described above, the reliability is a ratio at which the generated answer is evaluated to be correct by another generative AI. A case where the reliability of the generated answer is high means that the generated answer is evaluated to be correct from more pieces of generative AI as compared with the case where the reliability is low. The generated answer evaluated to be correct from more pieces of generative AI may be highly likely to be a correct answer. Therefore, the mutual evaluation unit 105 can determine whether each generated answer is a correct answer by comparing the reliability calculated for each generated answer with the reliability threshold value. The reliability threshold value can be set to any value. The reliability threshold value may be set by a user, for example.

The mutual evaluation unit 105 can cause other pieces of generative AI to mutually evaluate the generative AI by performing mutual evaluation on each generated answer. For example, in some cases, for a generated answer whose calculated reliability is equal to or more than the reliability threshold value, there is a high possibility that the generated answer is a correct answer. On the other hand, in some cases, for a generated answer whose calculated reliability is lower than the reliability threshold value, there is a low possibility that the generated answer is a correct answer. As described above, the mutual evaluation unit 105 can cause the pieces of generative AI to mutually evaluate whether each generated answer is a correct answer.

The above-described answer creation unit 104 creates an output answer according to the reliability of each generated answer. The output answer created by the answer creation unit 104 will be described again.

First, a case where there is a generated answer having reliability that is equal to or more than the reliability threshold value among a plurality of generated answers will be described. As illustrated in an example in FIG. 8, in a case where there is a generated answer having reliability that is equal to or more than the reliability threshold value among the plurality of generated answers, the answer creation unit 104 creates an output answer based on a generated answer having high reliability that is equal to or more than the reliability threshold value.

As described above, in some cases, for a generated answer whose calculated reliability is equal to or more than the reliability threshold value, there is a high possibility that the generated answer is a correct answer. Therefore, the answer creation unit 104 creates, for example, a summary of the generated answer having reliability that is equal to or more than the reliability threshold value, as the output answer. On the other hand, in some cases, for a generated answer whose calculated reliability is lower than the reliability threshold value, there is a low possibility that the generated answer is a correct answer. Therefore, the generated answer whose calculated reliability is lower than the reliability threshold value is not used to create the output answer.

The answer creation unit 104 creates an output answer by using a known natural language generation technique. The answer creation unit 104 may request the generative AI having the highest reliability of the generated answer to create the output answer. For example, the answer creation unit 104 may request the generative AI that has generated the generated answer having the highest reliability to create a summary of the generated answer having the reliability that is equal to or more than the reliability threshold value.

For example, in the example of FIG. 8, the reliability of the generated answer by the generative AIa is the highest. Therefore, the answer creation unit 104 may request the generative AIa to create a summary of the generated answer having the reliability that is equal to or more than the reliability threshold value. At this time, the answer creation unit 104 transmits the generated answer having the reliability that is equal to or more than the reliability threshold value, and an instruction to create a summary of the generated answer having the reliability that is equal to or more than the reliability threshold value, to the generative AIa. The generative AIa generates a summary based on the generated answer received from the answer creation unit 104. The generative AIa outputs the generated summary to the answer creation unit 104. The answer creation unit 104 can receive the summary from the generative AIa.

In a case where there are a plurality of generated answers having the reliability that is equal to or more than the reliability threshold value, the answer creation unit 104 may generate an output answer indicating the possibility that there are a plurality of answers to the user question.

As described above, the case where the matching rate is lower than the matching rate threshold value means a case where each piece of generative AI generates a generated answer having different contents. The case where each piece of generative AI generates the generated answer having different contents includes a case where some pieces of generative AI do not generate a correct answer and a case where there may be a plurality of correct answers to the user question. In a case where there are a plurality of generated answers having the reliability that is equal to or more than the reliability threshold value, all of the generated answers may be correct answers. That is, a plurality of correct answers to a user question by the user may be provided for the user question.

Therefore, in a case where there are a plurality of generated answers having the reliability that is equal to or more than the reliability threshold value, the answer creation unit 104 may generate an output answer including an expression indicating the possibility that there are a plurality of answers to the user question, for example. For example, the answer creation unit 104 may create an output answer including a sentence “this is a question that can give a plurality of answers.” as an expression indicating the possibility that there are a plurality of answers to the user question. An example of the expression indicating the possibility that there are a plurality of answers to the user question is not limited to this. At this time, the output answer includes the expression indicating the possibility that there are a plurality of answers to the user question, and a summary of the generated answer having the reliability that is equal to or more than the reliability threshold value.

Next, a case where there is no generated answer having the reliability that is equal to or more than the reliability threshold value will be described. In a case where there is no generated answer having the reliability that is equal to or more than the reliability threshold value, the answer creation unit 104 creates an output answer for requesting the user to change the user question. In a case where there is no generated answer having the reliability that is equal to or more than the reliability threshold value, there is a possibility that all pieces of the generative AIs have not generated correct answers. One of the reasons why the generative AI does not generate a correct answer is that the user question is not appropriate. Therefore, the answer creation unit 104 can request the user to change the user question in the output answer. For example, there is a case where a correct answer can be obtained from the generative AI by the user changing to an appropriate user question.

The answer creation unit 104 creates an output answer including an expression requesting the user to change the user question. An example of the output answer for requesting the user to change the user question is an output answer including a sentence “please ask again”. The output answer may include a sentence “please correct the question”. The answer creation unit 104 may create an output answer indicating that it is not possible to obtain a correct answer from the generative AI. For example, the answer creation unit 104 may create an output answer including a sentence “there is a possibility that a correct answer cannot be obtained”.

The output unit 106 is an aspect of output means for outputting an output answer. The output unit 106 outputs the output answer created by the answer creation unit 104. As described above, the output answer is an answer output to the user who has asked a question. The output unit 106 outputs the output answer to, for example, the user terminal 90. The user terminal 90 receives the output answer from the output unit 106. The user terminal 90 can display the output answer on the screen of the user terminal 90. For example, in a case where the user transmits a user question in a chat form, the user terminal 90 can display an output answer in a chat form as an answer to the user question. The display form on the screen of the user terminal 90 is not limited to this. The user terminal 90 that has received the output answer from the output unit 106 may output the output answer by voice.

The output unit 106 outputs a different output answer in accordance with the matching rate of the generated answer. In a case where the matching rate is equal to or more than the matching rate threshold value, the output unit 106 outputs the output answer created based on the generated answers by the plurality of pieces of generative AI. As a specific example, the output unit 106 can output a summary of all generated answers, as the output answer.

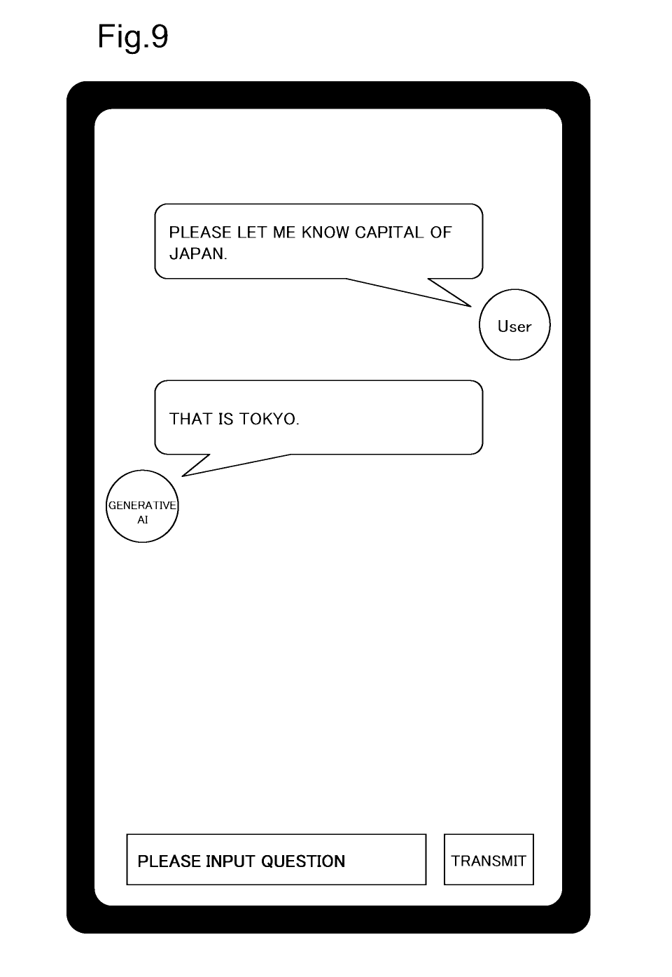

An example of screen display of the user terminal 90 in a case where the matching rate is equal to or more than the matching rate threshold value will be described with reference to FIG. 9. FIG. 9 is a first diagram illustrating an example of a screen on which an output answer is displayed. In the example illustrated in FIG. 9, a user question and an output answer are displayed in a chat format. In a case where the matching rate is equal to or more than the matching rate threshold value, the output unit 106 outputs the output answer created based on the generated answers by the plurality of pieces of generative AI to the user terminal 90. The user terminal 90 displays the output answer created based on the generated answers by the plurality of pieces of generative AI, on the screen. In the example of FIG. 9, “Tokyo” is displayed as the output answer. The display form of the user question and the output answer is not limited to this. The user question and the output answer may be displayed in a form in which checking by the user is possible.

In a case where the matching rate is lower than the matching rate threshold value, the output unit 106 outputs a different output answer depending on the reliability of the generated answer. In a case where there is a generated answer having the reliability that is equal to or more than the reliability threshold value, the output unit 106 can output an output answer created based on the generated answer having the reliability that is equal to or more than the reliability threshold value. As a specific example, the output unit 106 may output, as the output answer, a summary of the generated answer having high reliability that is equal to or more than the reliability threshold value, for example.

In a case where there are a plurality of generated answers having the reliability that is equal to or more than the reliability threshold value, the output unit 106 may output an output answer indicating the possibility that there are a plurality of answers to the user question. As described above, in a case where there are a plurality of generated answers having the reliability that is equal to or more than the reliability threshold value, the answer creation unit 104 may generate an output answer including an expression indicating the possibility that there are a plurality of answers to the user question, for example. Therefore, the output unit 106 can output an output answer including an expression indicating the possibility that there are a plurality of answers to the user question.

In addition, in a case where there are a plurality of generated answers having the reliability that is equal to or more than the reliability threshold value, the output unit 106 may output, to the user, a selection request as to whether to ask a question to the generative AI again. In a case where there are a plurality of generated answers having the reliability that is equal to or more than the reliability threshold value, there is a possibility that there may be a plurality of correct answers to the user question. At this time, for example, since the user question is not appropriate, the user question may have a plurality of correct answers. Therefore, there is a case where the user can obtain an appropriate answer by improving the user question. Therefore, the output unit 106 may output a selection request as to whether to ask a question to the generative AI again. The user can determine whether to ask a question again.

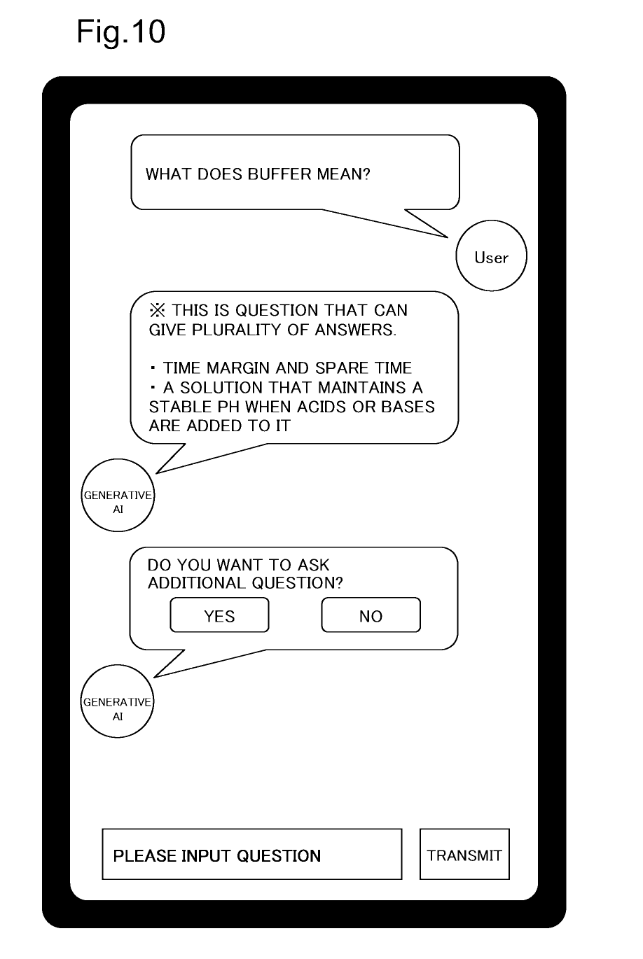

An example of screen display of the user terminal 90 in a case where the matching rate is lower than the matching rate threshold value and there are a plurality of generated answers having the reliability that is equal to or more than the reliability threshold value will be described with reference to FIG. 10. FIG. 10 is a second diagram illustrating an example of a screen on which an output answer is displayed. In FIG. 10, a user question and an output answer are displayed in a chat format. An output answer in a case where there are a plurality of generated answers having the reliability that is equal to or more than the reliability threshold value includes a summary of the generated answer having the reliability that is equal to or higher than the reliability threshold value and an expression indicating the possibility that there are a plurality of answers to the user question. In FIG. 10, the generated answers are listed in itemized form as the summary of the generated answers having the reliability that is equal to or more than the reliability threshold value. A sentence “this is a question that can give a plurality of answers.” is displayed in a balloon on the screen as the output answer including an expression indicating the possibility that there are a plurality of answers to the user question. A specific sentence indicating the possibility that there are a plurality of answers to the user question is not limited to this. The display form on the user terminal 90 is not limited to this.

The output unit 106 outputs a screen on which the user can select whether to ask an additional question. For example, the output unit 106 outputs, to the user terminal 90, an output answer including a selection request as to whether to ask an additional question. The output unit 106 causes the user terminal 90 to display a screen on which whether to ask an additional question can be selected. In a case where there are a plurality of generated answers having the reliability that is equal to or more than the reliability threshold value, there is a possibility that there may be a plurality of correct answers to the user question. In such a case, for example, the user may be able to obtain an appropriate answer by changing the user question. That is, the user may be able to obtain an appropriate answer required by the user among a plurality of correct answers. Therefore, the answer creation unit 104 may create an output answer including a selection request as to whether to ask an additional question. An example of the output answer including the selection request as to whether to ask an additional question is a sentence “do you want to ask an additional question?” illustrated in FIG. 10.

In FIG. 10, as an example of the screen on which selection as to whether to ask an additional question is possible, a balloon displaying a sentence “do you want to ask an additional question?”, and a “Yes” button and a “No” button are displayed on the screen in the user terminal 90. In a case where the user wants to ask an additional question, the user presses the “Yes” button. In a case where the user presses the “Yes” button, the screen may be switched to a screen on which the user can input a question. In a case where the user presses the “No” button, the chat may be ended.

The output answer including the selection request as to whether to ask an additional question may further include a sentence requesting an input of an additional question in a case where the user desires to ask an additional question. The output answer may include, for example, a sentence “to provide an additional question, please input the additional question”. In this case, in a case where the user does not input an additional question, the user may select not to ask the additional question.

In a case where there is no generated answer having the reliability that is equal to or more than the reliability threshold value, the output unit 106 outputs an output answer for requesting the user to change the user question. In a case where there is no generated answer having the reliability that is equal to or more than the reliability threshold value, there is a possibility that all pieces of the generative AIs have not generated correct answers. For example, there is a case where a correct answer can be obtained from the generative AI by the user changing to an appropriate user question. Therefore, in a case where there is no generated answer having the reliability that is equal to or more than the reliability threshold value, the answer creation unit 104 can create an output answer for requesting the user to change the user question. The output unit 106 outputs the output answer for requesting the user to change the user question, which has been created by the answer creation unit 104.

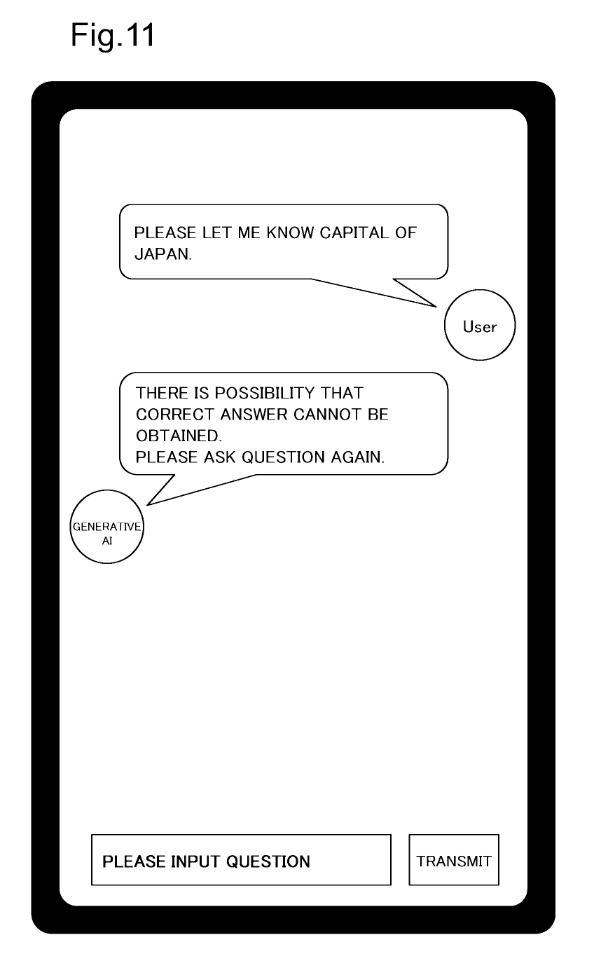

An example of screen display of the user terminal 90 in a case where the matching rate is lower than the matching rate threshold value and there is no generated answer having the reliability that is equal to or more than the reliability threshold value will be described with reference to FIG. 11. FIG. 11 is a third diagram illustrating an example of a screen on which an output answer is displayed. In FIG. 11, a user question and an output answer are displayed in a chat format. The output answer in a case where there is no generated answer having the reliability that is equal to or more than the reliability threshold value includes, for example, an expression requesting the user to change the user question. In FIG. 11, a sentence “please ask a question again.” is displayed in a balloon on the screen as the output answer including an expression requesting the user to change the user question. The user can ascertain that the question of the user needs to be changed by viewing this screen. For example, the user can input a new user question in a text box.

The user terminal 90 may display a sentence indicating that it is not possible to obtain a correct answer from the generative AI. In FIG. 11, a sentence “there is a possibility that a correct answer cannot be obtained.” is displayed. By displaying the sentence requesting the user to change the user question together with the sentence indicating that it is not possible to obtain a correct answer from the generative AI, the user can recognize the reason why it is necessary to change the question. Here, the specific sentence of the output answer is not limited to this. The display form on the user terminal 90 is not limited to this.

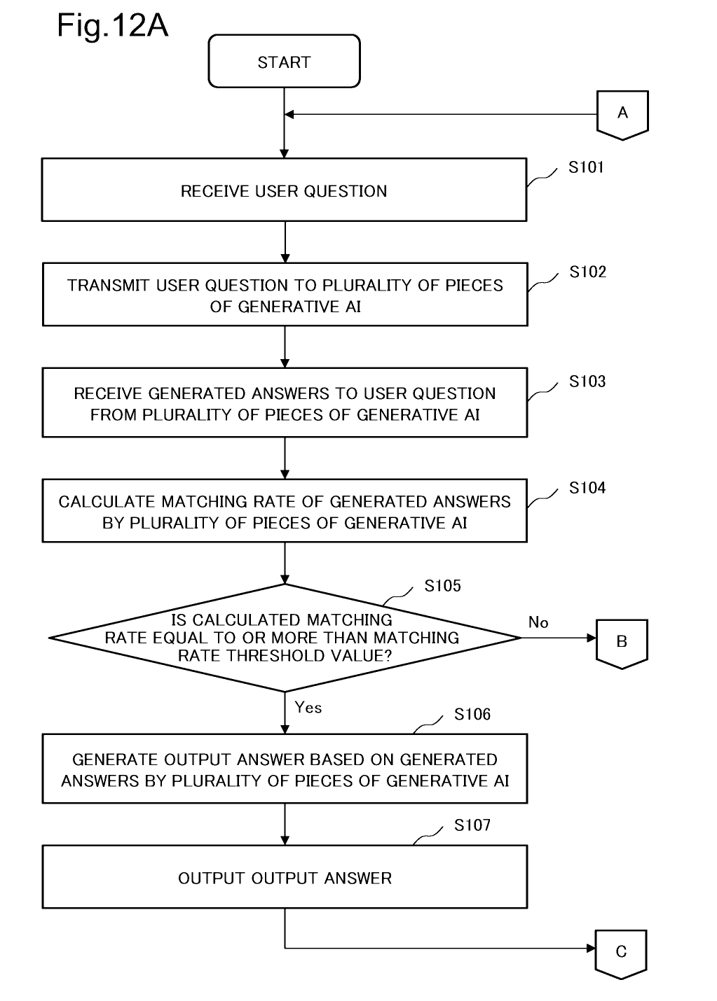

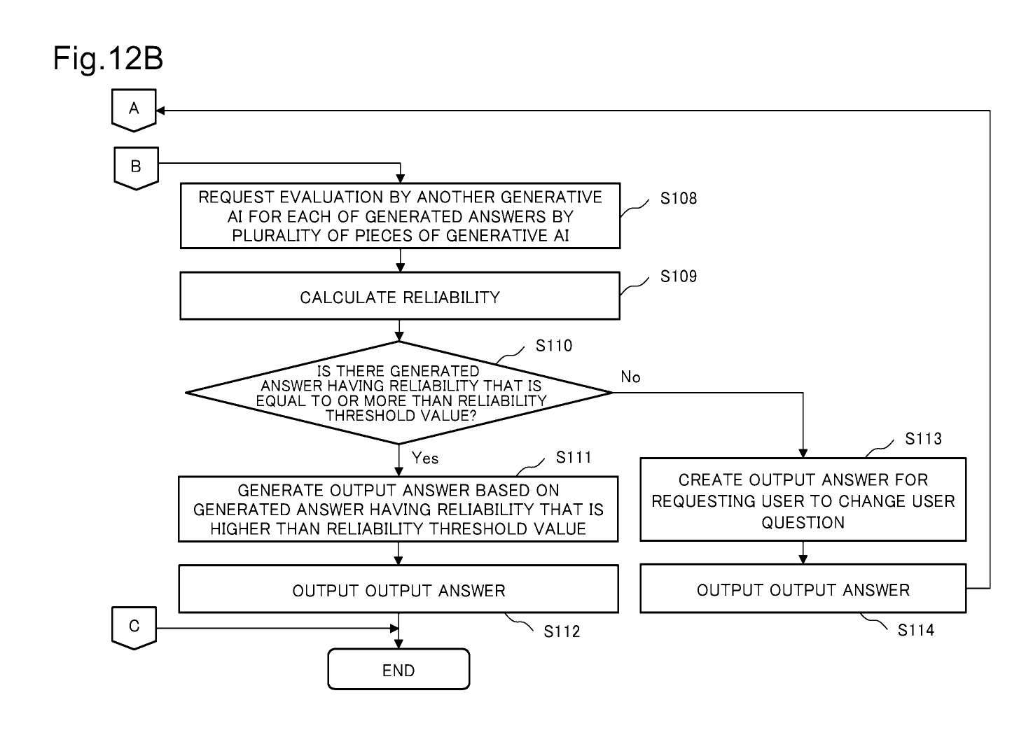

An operation of the answer support apparatus 10 including the question reception unit 101, the answer request unit 102, the matching rate calculation unit 103, the answer creation unit 104, the mutual evaluation unit 105, and the output unit 106 will be described with reference to FIGS. 12A and 12B. FIG. 12A is a first flowchart illustrating an example of the operation of the answer support apparatus. FIG. 12B is a second flowchart illustrating an example of the operation of the answer support apparatus.

In Step S101, the question reception unit 101 receives a user question. In Step S102, the answer request unit 102 transmits the user question to a plurality of pieces of generative AI. In Step S103, the answer request unit 102 receives a generated answer generated for the user question from the plurality of pieces of generative AI. In Step S104, the matching rate calculation unit 103 calculates a matching rate of generated answers generated by a plurality of pieces of generative AI. In Step S105, the matching rate calculation unit 103 compares the calculated matching rate with a matching rate threshold value. The matching rate calculation unit 103 determines whether the calculated matching rate is equal to or more than the matching rate threshold value.

In the case of Yes in Step S105, in Step S106, the answer creation unit 104 creates the output answer based on the generated answers by the plurality of pieces of generative AI. The case of Yes in Step S105 is a case where the matching rate is equal to or more than the matching rate threshold value. In Step S107, the output unit 106 outputs the output answer. Then, the answer support apparatus 10 ends the operation.

In the case of No in Step S105, in Step S108, the mutual evaluation unit 105 requests evaluation by another generative AI for each of the generated answers by the plurality of pieces of generative AI. The case of No in Step S105 is a case where the matching rate is lower than the matching rate threshold value. In Step S109, the mutual evaluation unit 105 calculates the reliability. In Step S110, the mutual evaluation unit 105 compares the calculated reliability with a reliability threshold value. The mutual evaluation unit 105 determines whether there is a generated answer whose calculated reliability is equal to or more than the reliability threshold value.

In the case of Yes in Step S110, in Step S111, the answer creation unit 104 creates an output answer based on the generated answer having reliability that is equal to or more than the reliability threshold value. The case of Yes in Step S110 is a case where there is the generated answer having the reliability that is equal to or more than the reliability threshold value. In Step S112, the output unit 106 outputs the output answer. Then, the answer support apparatus 10 ends the operation.

In the case of No in Step S110, in Step S113, the answer creation unit 104 creates an output answer for requesting the user to change the user question. The case of No in Step S110 is a case where there is no generated answer having the reliability that is equal to or more than the reliability threshold value. In Step S114, the output unit 106 outputs the output answer. Then, the process returns to Step S101. The user who has checked the output answer output in Step S114 inputs the changed user question. Therefore, in Step S101, the question reception unit 101 receives a user question changed by the user.

In the present example embodiment, the answer support apparatus 10 includes the answer request unit 102 that transmits a user question to a plurality of pieces of generative AI and receives a generated answer generated for the user question from the plurality of pieces of generative AI, the matching rate calculation unit 103 that calculates a matching rate of generated answers by the plurality of pieces of generative AI, the answer creation unit 104 that, in a case where the matching rate is equal to or more than a matching rate threshold value, creates an output answer based on the generated answers by the plurality of pieces of generative AI, and the mutual evaluation unit 105 that, in a case where the matching rate is lower than the matching rate threshold value, requests generative AI different from the generative AI that has generated the generated answer among the plurality of pieces of generative AI for evaluation for each of a plurality of generated answers, and calculates reliability based on an evaluation result. In a case where there is a generated answer having the reliability that is equal to or more than the reliability threshold value, the answer creation unit 104 can create an output answer based on the generated answer having the reliability that is equal to or more than the reliability threshold value. In a case where there is no generated answer having the reliability that is equal to or more than the reliability threshold value, the answer creation unit 104 creates an output answer for requesting the user to change the user question. Here, the answer generated by the generative AI is not appropriate in some cases. Therefore, the user may take time and effort to determine whether the answer by the generative AI is appropriate. The user may, for example, need to determine whether the answer is appropriate, by himself/herself. For example, the user additionally asks a question as to whether the answer is appropriate, to the generative AI, or asks the question to another generative AI. However, with the configuration of the answer support apparatus 10, the user can easily determine the appropriateness of the answer generated by the generative AI.

The answer generated by the generative AI is not appropriate in some cases. For example, there is a case where the answer by the generative AI is not correct, that is, the answer is incorrect. At this time, for example, the user may need to determine whether the answer is correct, by himself/herself. However, it may be difficult for the user himself/herself to determine whether the answer of the generative AI is a correct answer. The user may misunderstand that an incorrect answer is a correct answer. In order to determine whether the answer is correct, for example, the user may additionally ask, to the generative AI, a question as to whether the answer is correct or may ask the question to another generative AI. As described above, the user may take time and effort to determine whether the answer by the generative AI is correct.

However, in the answer support apparatus 10, the matching rate calculation unit 103 calculates the matching rate and compares the matching rate with the matching rate threshold value. The correctness of the generated answer can be determined by the magnitude relationship between the matching rate and the matching rate threshold value. In a case where the matching rate is equal to or more than the matching rate threshold value, there is a high possibility that the contents of the generated answers by all the generative AIs are correct. At this time, the answer creation unit 104 creates an output answer based on the generated answers by a plurality of pieces of generative AI, and the output unit 106 outputs the output answer. As a result, the user can obtain an answer that is highly likely to be correct. That is, it is possible to save time and effort for the user to determine the correctness of the answer or to ask an additional question to the generative AI. Thus, the user can easily determine the appropriateness of the answer generated by the generative AI.

Even in a case where the matching rate is lower than the matching rate threshold value, the mutual evaluation unit 105 calculates the reliability for each generated answer. The mutual evaluation unit 105 can determine whether there is a high possibility that each generated answer is a correct answer by comparing the reliability with the reliability threshold value. Thus, the user can easily determine the appropriateness of the answer generated by the generative AI.

In the answer support apparatus 10 in the present example embodiment, the answer request unit 102 transmits a user question to a plurality of pieces of generative AI. Here, for example, learning contents are different depending on the generative AI. Therefore, even though the same question is asked to a plurality of pieces of generative AI, answers with different contents may be generated. That is, the user may be able to obtain a plurality of answers to one user question. In a case where the user uses one generative AI, it may be difficult to obtain a plurality of answers to one user question. Therefore, obtaining a plurality of answers may be beneficial for the user.

By the way, in a case where answers of different contents are generated in a plurality of pieces of generative AI, the user may determine whether each answer is a correct answer. The user may have difficulty in determining whether each generated answer is correct. However, in the answer support apparatus 10, the mutual evaluation unit 105 requests evaluation by another generative AI for each of the generated answers by the plurality of pieces of generative AI, and calculates the reliability based on the evaluation result. That is, even in a case where answers of different contents are generated in a plurality of pieces of generative AI, it is possible to determine whether the generated answer is a correct answer by another generative AI evaluating the generated answer. Thus, the user can easily determine the appropriateness of the answer generated by the generative AI.

In the present example embodiment, in a case where there are a plurality of generated answers having the reliability that is equal to or more than the reliability threshold value, the answer creation unit 104 creates an output answer indicating the possibility that there are a plurality of answers to the user question. A plurality of correct answers may be provided for a user question. At this time, a plurality of pieces of generative AI may generate answers having different contents. For example, even though each generated answer has correct content, there is a case where an answer that is different from the answer requested by the user is included. Also in this case, it can be said that the generated answer is not an appropriate answer.

Therefore, the answer creation unit 104 creates an output answer indicating the possibility that there are a plurality of answers to the user question, and the output unit 106 outputs the output answer, thus the user can recognize that there may be a plurality of correct answers to the user question input by the user. The user can ask an additional question to the generative AI as necessary. Thus, it is possible to improve the possibility that the user can obtain an appropriate answer.

In the present example embodiment, the answer creation unit 104 requests the generative AI having the highest reliability to create an output answer. By requesting the generative AI having the highest reliability to create an output answer, the possibility of creating a good output answer is improved. The good output answer is, for example, an output answer that is easy for the user to understand. Examples of the good output answer are not limited to these. Since the answer creation unit 104 requests the generative AI mounted on the generation server 91 connected to the answer support apparatus 10 to create an output answer, it is possible to reduce the processing in the answer support apparatus 10.

### Second Example Embodiment

A second example embodiment will be described in detail with reference to the drawings. Hereinafter, the description of content overlapping with the above description will be omitted to the extent that description of the present example embodiment is not unclear.

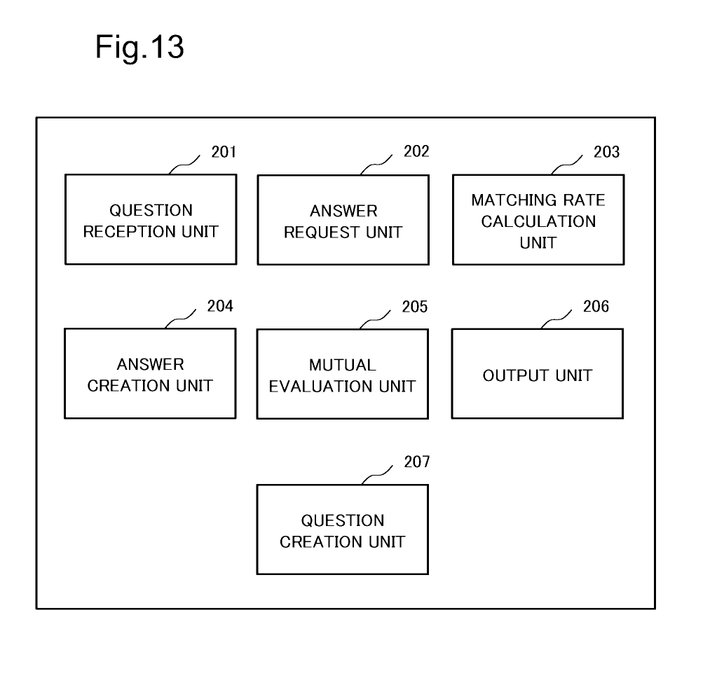

A configuration of an answer support apparatus 20 will be described with reference to FIG. 13. FIG. 13 is a block diagram illustrating an example of the configuration of the answer support apparatus.

The answer support apparatus 20 in the present example embodiment includes a question creation unit 207 as compared with the answer support apparatus 10 in the above-described example embodiment. A question reception unit 201, an answer request unit 202, a matching rate calculation unit 203, an answer creation unit 204, a mutual evaluation unit 205, and an output unit 206 in the answer support apparatus 20 are relevant to the question reception unit 101, the answer request unit 102, the matching rate calculation unit 103, the answer creation unit 104, the mutual evaluation unit 105, and the output unit 106, respectively.

The question creation unit 207 is an aspect of question creation means for, in a case where a matching rate is lower than a matching rate threshold value, creating an alternative question having a possibility of obtaining an appropriate answer to the user question based on the past user question and output answer. As described above, the matching rate calculation unit 203 calculates the matching rate. The matching rate calculation unit 203 compares the calculated matching rate with the matching rate threshold value. In a case where the matching rate is lower than the matching rate threshold value, the question creation unit 207 creates an alternative question having a possibility of obtaining an appropriate answer to the user question.

A case where the matching rate is lower than the matching rate threshold value means a case where each piece of generative AI generates a generated answer having different contents. The case where each piece of generative AI generates a generated answer having different contents is, for example, a case where some pieces of generative AI do not generate a correct answer or a case where there may be a plurality of correct answers to the user question. For example, in a case where there may be a plurality of correct answers to the user question, a plurality of answers may include an answer different from the answer required by the user. Specifically, each generated answer is not an incorrect answer to the user question, but may include an answer that is different from the answer required by the user. Examples of the reason include a case where the user question is not appropriate. Therefore, there is a case where the user can obtain an appropriate answer by transmitting a new user question to a plurality of pieces of generative AI.

The question creation unit 207 creates an alternative question as a candidate for a new user question. The alternative question is a question having a possibility that an appropriate answer to a user question can be obtained. The question having a possibility that an appropriate answer to the user question can be obtained is, for example, a question that uniquely determines the content of the answer. That is, the question having a possibility that an appropriate answer to the user question can be obtained is a question having a high possibility that the contents of the generated answers by a plurality of pieces of generative AI match with each other in a case where the plurality of pieces of generative AI are questioned. For example, in a case where there may be a plurality of correct answers to the user question, a plurality of answers may include an answer different from the answer required by the user. Therefore, there is a case where the user can obtain an answer required by the user by the question having the possibility that an appropriate answer to the user question can be obtained.

The question having the possibility that an appropriate answer to the user question can be obtained may be, for example, a question in which the generative AI can generate a correct answer. In a case where some or all pieces of generative AI have not generated a correct answer, a correct answer may be obtained by the question having the possibility that an appropriate answer to the user question can be obtained.

Examples of the question having the possibility that an appropriate answer to the user question can be obtained are not limited to these. The alternative question may be, for example, a question capable of clarifying the intention of the question of the user. For example, the user wants to know the meaning of a certain word in a specific field, but depending on the generative AI, the meaning in a different field may be answered. At this time, there is a case where the intention of the question of the user that the user wants to know the meaning of the word in the specific field is not reflected in the user question. Therefore, the question creation unit 207 may create a question capable of clarifying the intention of the question of the user as an alternative question. An example of an alternative question is a question capable of specifying a genre to which an already transmitted user question relates. The genre is a field, an industry, or a situation related to the user question. The genre is not limited to this. The genre and the question that can be specified are questions obtained by narrowing down the genre associated with the user question. In the user question, since the genre related to the user question is not narrowed down, there may be a plurality of correct answers to the user question. Therefore, the alternative question is a question capable of narrowing down the genre associated with the user question.

A method of creating an alternative question by the question creation unit 207 will be described. The question creation unit 207 creates an alternative question based on the past user question and output answer. The past user question and output answer are a user question transmitted to the generative AI in the past and an output answer to the user question. A combination of a user question transmitted to the generative AI in the past and an output answer to the user question is referred to as a question history.

The question creation unit 207 creates a question similar to the user question as an alternative question from the question history. The alternative question may be a user question included in the question history. The alternative question may be a question obtained by correcting the user question included in the question history. The alternative question may be a question obtained by combining the user question included in the question history and the already transmitted user question. The question creation unit 207 may create an alternative question by using the user question included in the question history. The alternative question may be a user question obtained by improving the user question already transmitted to the generative AI.

In order to generate a question similar to the user question from the question history, a known natural language processing technique and a known method of comparing sentence distributed expressions are used. The method of creating the alternative question is not limited to this. The question creation unit 207 may create one alternative question or may create a plurality of alternative questions. The number of generated alternative questions may be set by the user to any number, for example.

Here, the question history used to create the alternative question is a question history in a case where the matching rate is equal to or more than the matching rate threshold value, and a question history in a case where the reliability is equal to or more than the reliability threshold value. The case where the matching rate is equal to or more than the matching rate threshold value is, for example, a case where contents of generated answers by a plurality of pieces of generative AI match with each other. That is, a user question in a case where the matching rate is equal to or more than the matching rate threshold value can be said to be an example of a question from which an appropriate answer can be obtained. Therefore, the question history in a case where the matching rate is equal to or more than the matching rate threshold value is used for creation of an alternative question by the question creation unit 207. The case where the reliability is equal to or higher than the reliability threshold value is a case where a ratio of a certain generated answer evaluated to be correct from another generative AI is high. This is a case where there is a high possibility that the generated answer having reliability that is equal to or more than the reliability threshold value is a correct answer. The user question in a case where the reliability is equal to or more than the reliability threshold can be said to be an example of a question from which an appropriate answer can be obtained. Therefore, the question history in a case where the matching rate is equal to or more than the matching rate threshold value is used for creation of an alternative question by the question creation unit 207.

The question history is stored, for example, in a database (not illustrated). The database may be stored in the answer support apparatus 20. The database may be stored in an information processing device (not illustrated) different from the answer support apparatus 20. At this time, the answer support apparatus 20 and the information processing device are connected via a wired or wireless network. The question history is stored in the database by the answer creation unit 204, for example.

In a case where the question creation unit 207 creates an alternative question, the answer creation unit 204 creates an output answer including the alternative question. The number of alternative questions included in the output answer may be one or plural. The number of alternative questions included in the output answer may be the same as the number of alternative questions created by the question creation unit 207.

Examples of output answers including an alternative question will be described in different cases.

In a case where the matching rate is lower than the matching rate threshold value, and there are a plurality of generated answers having the reliability that is equal to or more than the reliability threshold value, the output answer may include an expression indicating a possibility that there are a plurality of answers to the user question, a summary of generated answers having the reliability that is equal to or more than the reliability threshold value, and an alternative question. An example of the expression indicating the possibility that there are a plurality of answers to the user question is a sentence “this is a question that can give a plurality of answers”. The output answer may include a sentence requesting the user to select a question to be transmitted to the generative AI from a plurality of alternative questions, in addition to the alternative question. The output answer may include, for example, a sentence “please select a new question from the following questions to obtain a more appropriate answer”.

In a case where the matching rate is lower than the matching rate threshold value and there is no generated answer having the reliability that is equal to or more than the reliability threshold value, the output answer includes an expression requesting selection of a question to be transmitted to the generative AI from a plurality of alternative questions and an alternative question. The output answer including the alternative question is an example of an output answer for requesting the user to change the user question. The answer creation unit 204 may create an output answer indicating that it is not possible to obtain a correct answer from the generative AI.

The output unit 206 outputs the output answer created by the answer creation unit 204. The output unit 206 outputs an output answer including an alternative question. The output unit 206 may output a screen on which the user can select an alternative question to be transmitted to a plurality of pieces of generative AI from a plurality of alternative questions. For example, the output unit 206 outputs an output answer including a plurality of alternative questions to the user terminal 90. The output unit 206 causes the user terminal 90 to display a screen on which the alternative question to be transmitted to the plurality of pieces of generative AI can be selected from the plurality of alternative questions.

An output destination of the output answer by the output unit 206 is as described above. A display example of the screen of the user terminal 90 in a case where the output answer is output to the user terminal 90 by the output unit 206 will be described.

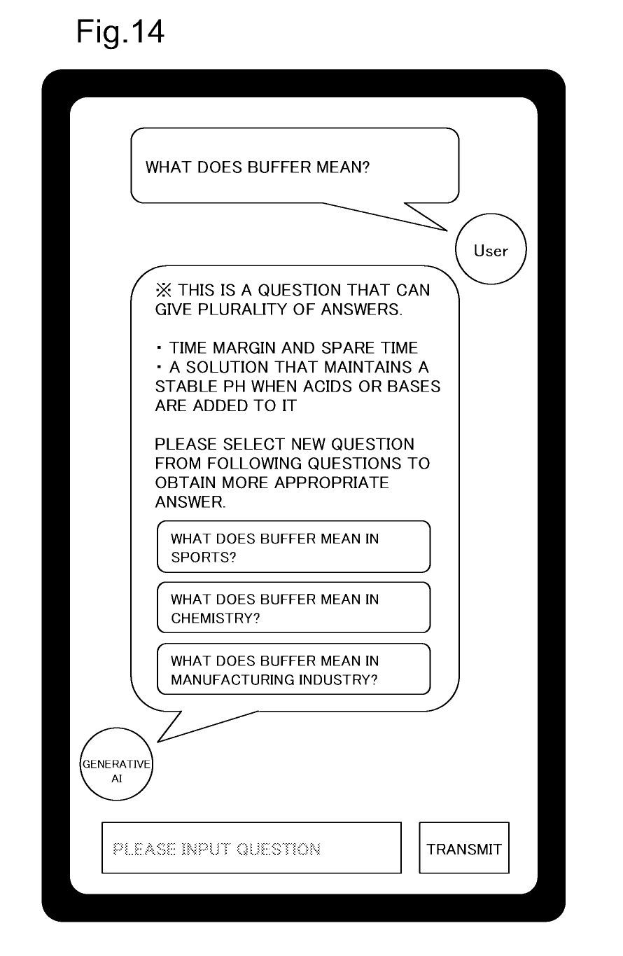

An example of screen display of the user terminal 90 in a case where the matching rate is lower than the matching rate threshold value and there are a plurality of generated answers having the reliability that is equal to or more than the reliability threshold value will be described with reference to FIG. 14. FIG. 14 is a first diagram illustrating an example of a screen on which an output answer including an alternative question is displayed. In FIG. 14, a user question and an output answer are displayed in a chat format. The output answer in a case where there are a plurality of generated answers having the reliability that is equal to or more than the reliability threshold value includes an expression indicating a possibility that there are a plurality of answers to the user question, a summary of the generated answers having the reliability that is equal to or more than the reliability threshold value, and an alternative question. The expression indicating the possibility that there are a plurality of answers to the user question and the summary of the generated answers having the reliability that is equal to or more than the reliability threshold value are similar to those in FIG. 10 described above.

In FIG. 14, after the summary of the generated answer, “please select a new question from the following questions to obtain a more appropriate answer.” is displayed as a sentence requesting selection of a question to be transmitted to the generative AI from a plurality of alternative questions. Three alternative questions are displayed. In the example illustrated in FIG. 14, the meaning of “buffer” is questioned in the user question. The word “buffer” may have different meanings depending on the field used. Therefore, in an alternative question, a question for specifying the field and asking the meaning of “buffer” is displayed. Each alternative question may be displayed in a form in which selection by the user is possible. For example, each alternative question is a button and can be pressed by the user. When the user presses any alternative question button, the alternative question is transmitted to a chat. That is, the question reception unit 201 receives the alternative question as the user question. The answer request unit 202 transmits the alternative question to the generative AI.

The display form of the alternative question is not limited to this. For example, there may be a check box for each alternative question, and the user may select an alternative question to be transmitted, by checking the check box. An alternative question may be transmitted to the chat by pressing a “transmit” button after selecting the alternative question.

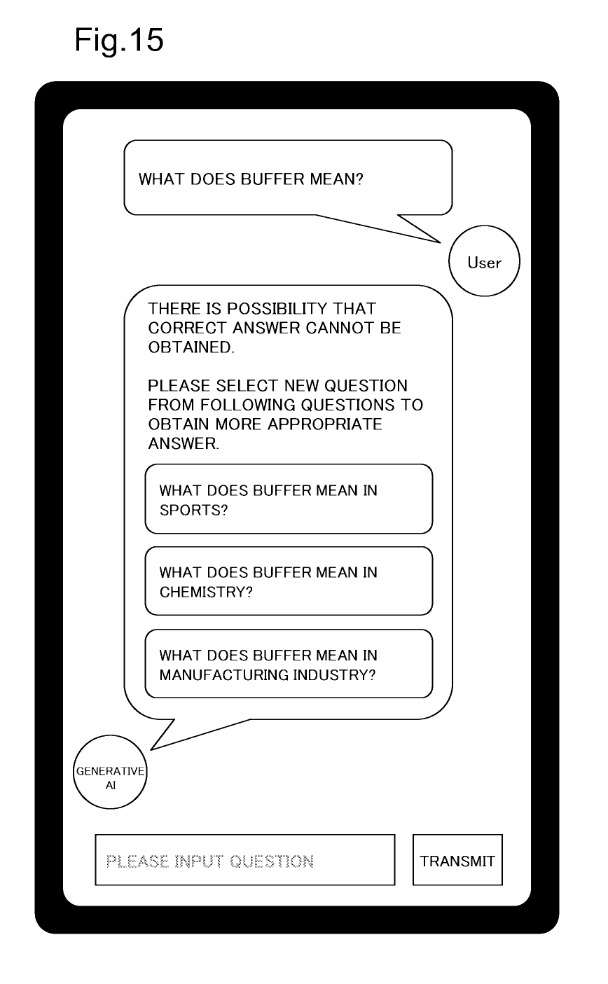

An example of screen display of the user terminal 90 in a case where the matching rate is lower than the matching rate threshold value and there is no generated answer having the reliability that is equal to or more than the reliability threshold value will be described with reference to FIG. 15. FIG. 15 is a second diagram illustrating an example of a screen on which an output answer including an alternative question is displayed. In FIG. 15, a user question and an output answer are displayed in a chat format. In an output answer illustrated as an example in FIG. 15, “there is a possibility that a correct answer cannot be obtained.” is displayed as an expression indicating that it is not possible to obtain a correct answer from the generative AI. An expression requesting selection of a question to be transmitted to the generative AI from a plurality of alternative questions and the alternative questions are displayed. Each alternative question may be a button. When the user presses any alternative question button, the alternative question is transmitted to a chat. The display form of the alternative question is not limited to this. As described above, for example, there may be a check box for each alternative question, and the user may select an alternative question to be transmitted, by checking the check box. An alternative question may be transmitted to the chat by pressing a “transmit” button after selecting the alternative question.

Furthermore, the output unit 206 may output a screen on which the alternative question selected by the user can be edited. In a case where the output unit 206 displays a screen on which an alternative question to be transmitted to a plurality of generative AI can be selected from a plurality of alternative questions, the user selects an alternative question to be transmitted. At this time, the user may want to edit the alternative question. Therefore, the output unit 206 may cause the user terminal 90 to display a screen on which the selected alternative question can be edited.

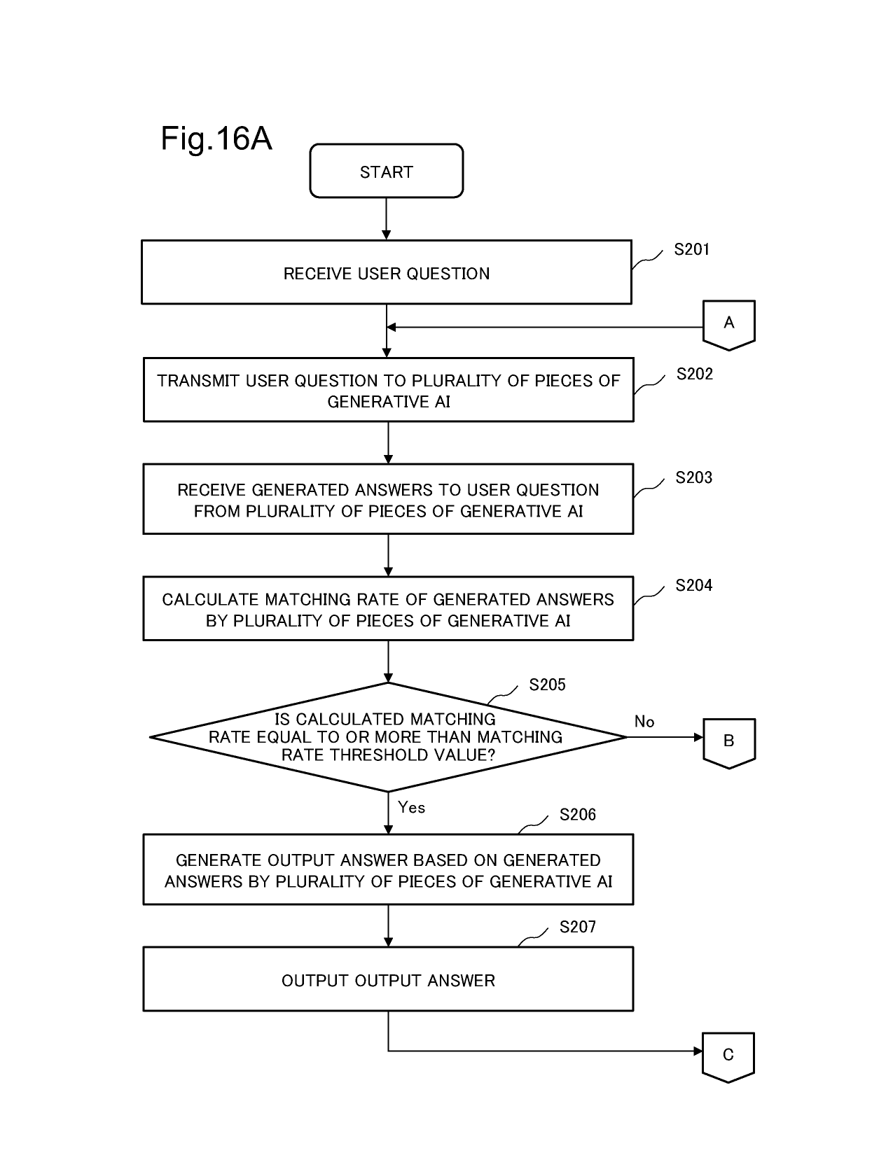

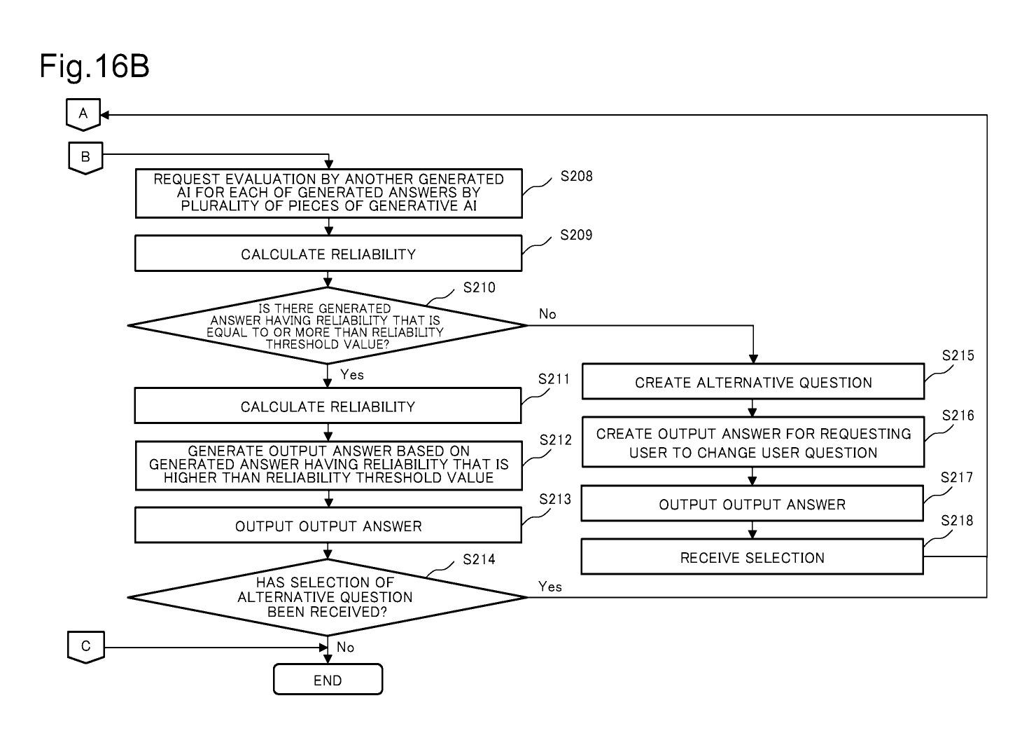

An operation of the answer support apparatus 20 including the question reception unit 201, the answer request unit 202, the matching rate calculation unit 203, the answer creation unit 204, the mutual evaluation unit 205, the output unit 206, and the question creation unit 207 will be described with reference to FIGS. 16A and 16B. FIG. 16A is a third flowchart illustrating an example of the operation of the answer support apparatus. FIG. 16B is a fourth flowchart illustrating an example of the operation of the answer support apparatus.

Steps S201 to S210 are similar to Steps S101 to S110 described in FIGS. 12A and 12B.

In the case of Yes in Step S210, in Step S211, the question creation unit 207 creates an alternative question having a possibility that an appropriate answer to the user question can be obtained, based on the past user question and output answer. The case of Yes in Step S210 is a case where there is the generated answer having the reliability that is equal to or more than the reliability threshold value. In Step S212, the answer creation unit 204 creates an output answer based on a generated answer having reliability that is equal to or higher than the reliability threshold value. In Step S213, the output unit 206 outputs the output answer. In Step S214, the question reception unit 201 determines whether selection of an alternative question included in the output answer has been received. In the case of Yes in Step S214, that is, in a case where the question reception unit 201 has received the selection of an alternative question, the process returns to Step S202. In the case of No in Step S214, that is, in a case where the selection of an alternative question has not been received, the answer support apparatus 20 ends the operation.

In the case of No in Step S210, in Step S215, the question creation unit 207 creates an alternative question having a possibility that an appropriate answer to the user question can be obtained, based on the past user question and output answer. The case of No in Step S110 is a case where there is no generated answer having the reliability that is equal to or more than the reliability threshold value. In Step S216, the answer creation unit 204 creates an output answer for requesting the user to change the user question. In Step S217, the output unit 206 outputs the output answer. In Step S218, the question reception unit 201 receives selection of an alternative question. Then, the process returns to Step S202.

The answer support apparatus 20 in the present example embodiment further includes the question creation unit 207 that, in a case where a matching rate is lower than a matching rate threshold value, creates an alternative question having a possibility of obtaining an appropriate answer to the user question based on the past user question and output answer. The output unit 206 creates an output answer including the alternative question. A case where the matching rate is lower than the matching rate threshold value means a case where each piece of generative AI generates a generated answer having different contents. The case where each piece of generative AI generates the generated answer having different contents includes a case where some pieces of generative AI do not generate a correct answer and a case where there may be a plurality of correct answers to the user question. At this time, there is a possibility that the user question is not appropriate. Therefore, the user may ask an additional question or the like. Therefore, since the question creation unit 207 creates an alternative question and the output unit 206 outputs an output answer including the alternative question, it is possible to save time and effort of the user from considering an additional question or the like. For example, even in a case where the user does not sufficiently understand the content of the user question or in a case where the user cannot properly express the content of the user question, the output answer including the alternative question is output, and thus the user can easily ask the question.

The question creation unit 207 creates an alternative question having a possibility that an appropriate answer to the user question can be obtained. The alternative question is, for example, a question capable of specifying a genre from the user question. Therefore, it is possible to improve the possibility that the user can obtain an appropriate answer.

In the present example embodiment, the output unit 206 outputs a screen on which the user can select an alternative question to be transmitted to a plurality of pieces of generative AI from a plurality of alternative questions. For example, the user can select a question from a plurality of alternative questions displayed on the user terminal 90. Therefore, it is possible to save time and effort of the user from considering an additional question or the like. Since a plurality of alternative questions are output, for example, the user can select one that seems to be close to the intention of the user. That is, it is possible to improve the possibility that the user can obtain an appropriate answer.

In the answer support apparatus 20 according to the present example embodiment, the past user question and output answer include a user question and an output answer in a case where the matching rate is equal to or more than the matching rate threshold value, and a user question and an output answer in a case where the reliability is equal to or more than the reliability threshold value. The case where the matching rate is equal to or more than the matching rate threshold value is, for example, a case where contents of generated answers by a plurality of pieces of generative AI match with each other. That is, a user question in a case where the matching rate is equal to or more than the matching rate threshold value can be said to be an example of a question from which an appropriate answer can be obtained. The case where the reliability is equal to or higher than the reliability threshold value is a case where a ratio of a certain generated answer evaluated to be correct from another generative AI is high. This is a case where there is a high possibility that the generated answer having reliability that is equal to or more than the reliability threshold value is a correct answer. The user question in a case where the reliability is equal to or more than the reliability threshold value can be said to be an example of a question from which an appropriate answer can be obtained. By using these question histories, the question creation unit 207 can create an alternative question having a higher possibility that an appropriate answer to the user question can be obtained.

In the present example embodiment, the output unit 206 outputs a screen on which the selected alternative question can be edited. In a case where the output unit 206 displays a screen on which an alternative question to be transmitted to a plurality of generative AI can be selected from a plurality of alternative questions, the user selects an alternative question to be transmitted. At this time, the user may want to edit the alternative question. For example, the user may come up with a better question while looking at the alternative question. At this time, the user may want to edit the alternative question. Therefore, the output unit 206 outputs a screen on which the selected alternative question can be edited, and thus the user can edit the alternative question. By enabling editing by the user, the user can ask a better question than the alternative question to the generative AI. Therefore, it is possible to improve the possibility that the user can obtain an appropriate answer.

### Hardware Configuration Example

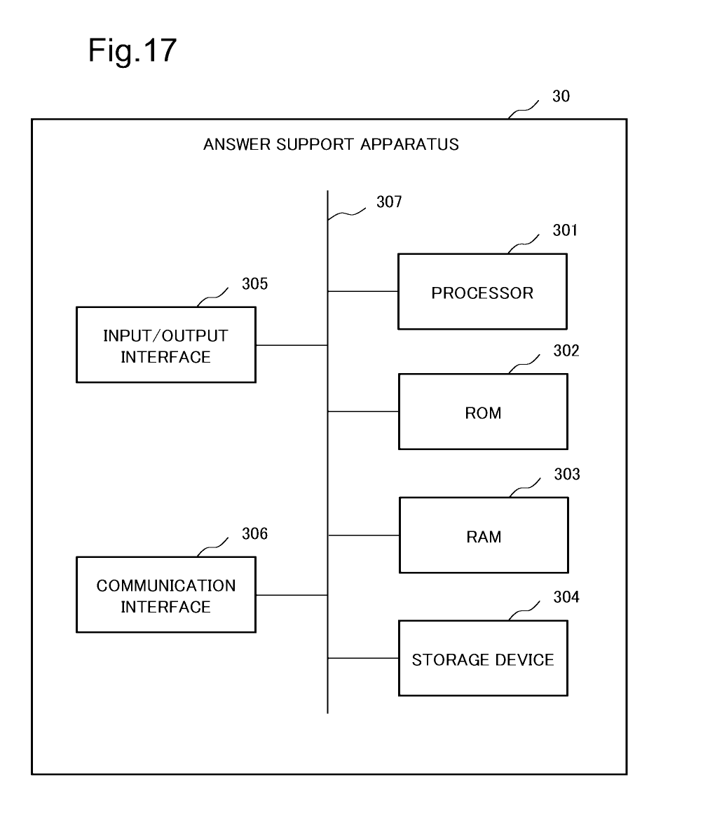

FIG. 17 is a diagram illustrating an example of a hardware configuration of the answer support apparatus. An answer support apparatus 30 is achieved by a computer. The answer support apparatus 30 is an example of a case where the answer support apparatus 10 or the answer support apparatus 20 is achieved by a computer.

The answer support apparatus 30 includes a processor 301, a read only memory (ROM) 302, a random access memory (RAM) 303, a storage device 304 such as a hard disk for storing programs, an input/output interface 305 for inputting/outputting data, and a communication interface 306 for network connection. The components are connected via a bus 307.

The processor 301 operates an operating system to control the entire computer. Examples of the processor 301 include a central processing unit (CPU), a digital signal processor (DSP), and a graphics processing unit (GPU). The processor 301 loads a program stored in, for example, the ROM 302, the storage device 304, or the like. The processor 301 executes each process coded in the program. The processor 301 may execute processing or instructions in the illustrated flowchart based on a program.

The ROM 302 stores an application program, a program according to each example embodiment, and the like. The RAM 303 is used as a work area of the processor 301.

Examples of the storage device 304 include a semiconductor memory such as a flash memory, a hard disk drive (HDD), and the like. The storage device 304 stores, for example, an operating system (OS) program, an application program, a program according to each example embodiment, and the like.

The input/output interface 305 is connected to a peripheral device (not illustrated). The connection method may be a wired network or a wireless network.

The communication interface 306 is connected to a communication network (not illustrated) such as a local network (LAN) or a wide area network (WAN) through a wireless or wired network. The communication network may include a plurality of communication networks. As a result, the computer is connected to an external device via the communication network. The answer support apparatus 30 may have components other than those illustrated in FIG. 17. For example, the answer support apparatus 30 may include a drive device or the like. For example, the processor 301 may be mounted on a drive device or the like, and may read a program or data stored in a non-transitory tangible recording medium into the RAM 303.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.

### Supplementary Note 1

An answer support apparatus including:

question reception means for receiving a user question by a user;

answer request means for transmitting the user question to a plurality of pieces of generative AI and receiving generated answers generated for the user question from a plurality of pieces of the generative AI;

matching rate calculation means for calculating a matching rate of the generated answers by the plurality of pieces of the generative AI;

answer creation means for creating an output answer based on the generated answers by the plurality of pieces of generative AI in a case where the matching rate is equal to or more than a matching rate threshold value;

output means for outputting the output answer; and

mutual evaluation means for, in a case where the matching rate is lower than the matching rate threshold value, requesting the generative AI different from the generative AI that has generated the generated answer among the plurality of pieces of the generative AI for evaluation for each of a plurality of the generated answers, and calculating reliability based on an evaluation result, in which

the answer creation means

creates the output answer based on the generated answer having the reliability that is equal to or more than a reliability threshold value in a case where there are the generated answers having the reliability that is equal to or more than the reliability threshold value, and

creates the output answer for requesting the user to change the user question in a case where there is no generated answer having the reliability that is equal to or more than the reliability threshold value.

### Supplementary Note 2

The answer support apparatus according to Supplementary Note 1, in which

the answer creation means creates the output answer indicating a possibility that there are a plurality of answers to the user question, in a case where there are a plurality of the generated answers having the reliability that is equal to or more than the reliability threshold value.

### Supplementary Note 3

The answer support apparatus according to Supplementary Note 1 or 2, in which

the answer creation means requests the generative AI having highest reliability to create the output answer.

### Supplementary Note 4

The answer support apparatus according to any one of Supplementary Notes 1 to 3, further including:

question creation means for creating an alternative question having a possibility of obtaining an appropriate answer to the user question based on the past user question and output answer in a case where the matching rate is lower than the matching rate threshold value, in which

the answer creation means creates the output answer including the alternative question.

### Supplementary Note 5

The answer support apparatus according to Supplementary Note 4, in which

the output means outputs a screen on which the user is able to select the alternative question to be transmitted to a plurality of pieces of the generative AI from a plurality of alternative questions.

### Supplementary Note 6

The answer support apparatus according to Supplementary Note 4 or 5, in which

the alternative question is a question capable of specifying a genre from the user question.

### Supplementary Note 7

The answer support apparatus according to any one of Supplementary Notes 4 to 6, in which

the past user question and output answer include the user question and the output answer in a case where the matching rate is equal to or more than the matching rate threshold value, and the user question and the output answer in a case where the reliability is equal to or more than the reliability threshold value.

### Supplementary Note 8

The answer support apparatus according to Supplementary Note 5, in which

the output means outputs a screen on which the selected alternative question is enabled to be edited.

### Supplementary Note 9

The answer support apparatus according to any one of Supplementary Notes 1 to 8, in which

the output means outputs a screen on which the user is able to select whether to ask an additional question.

### Supplementary Note 10

An answer support method including:

receiving a user question by a user;

transmitting the user question to a plurality of pieces of generative AI and receiving generated answers generated for the user question from a plurality of pieces of the generative AI;

calculating a matching rate of the generated answers by the plurality of pieces of the generative AI;

in a case where the matching rate is lower than a matching rate threshold value, requesting the generative AI different from the generative AI that has generated the generated answer among the plurality of pieces of the generative AI for evaluation for each of a plurality of the generated answers, and calculating reliability based on an evaluation result;

creating an output answer based on the generated answer having the reliability that is equal to or more than a reliability threshold value in a case where there are the generated answers having the reliability that is equal to or more than the reliability threshold value;

creating the output answer for requesting the user to change the user question in a case where there is no generated answer having the reliability that is equal to or more than the reliability threshold value;

creating the output answer based on the generated answers by a plurality of pieces of the generative AI in a case where the matching rate is equal to or more than the matching rate threshold value; and

outputting the output answer.

### Supplementary Note 11

A program for causing a computer to execute processing including:

receiving a user question by a user;

transmitting the user question to a plurality of pieces of generative AI and receiving generated answers generated for the user question from a plurality of pieces of the generative AI;

calculating a matching rate of the generated answers by the plurality of pieces of the generative AI;

in a case where the matching rate is lower than a matching rate threshold value, requesting the generative AI different from the generative AI that has generated the generated answer among the plurality of pieces of the generative AI for evaluation for each of a plurality of the generated answers, and calculating reliability based on an evaluation result;

creating an output answer based on the generated answer having the reliability that is equal to or more than a reliability threshold value in a case where there are the generated answers having the reliability that is equal to or more than the reliability threshold value;

creating the output answer for requesting the user to change the user question in a case where there is no generated answer having the reliability that is equal to or more than the reliability threshold value;

creating the output answer based on the generated answers by a plurality of pieces of the generative AI in a case where the matching rate is equal to or more than the matching rate threshold value; and

outputting the output answer.

### Supplementary Note 12

A recording medium storing a program for causing a computer to execute processing including:

receiving a user question by a user;

transmitting the user question to a plurality of pieces of generative AI and receiving generated answers generated for the user question from a plurality of pieces of the generative AI;

calculating a matching rate of the generated answers by the plurality of pieces of the generative AI;

in a case where the matching rate is lower than a matching rate threshold value, requesting the generative AI different from the generative AI that has generated the generated answer among the plurality of pieces of the generative AI for evaluation for each of a plurality of the generated answers, and calculating reliability based on an evaluation result;

creating an output answer based on the generated answer having the reliability that is equal to or more than a reliability threshold value in a case where there are the generated answers having the reliability that is equal to or more than the reliability threshold value;

creating the output answer for requesting the user to change the user question in a case where there is no generated answer having the reliability that is equal to or more than the reliability threshold value;

creating the output answer based on the generated answers by a plurality of pieces of the generative AI in a case where the matching rate is equal to or more than the matching rate threshold value; and

outputting the output answer.

Some or all of the configurations described in Supplementary Notes 2 to 9 dependent on the above-described Supplementary Note 1 can also be dependent on Supplementary Notes 10 to 12 by the dependency relationship similar to that of Supplementary Notes 2 to 9. Furthermore, some or all of the configurations described as the Supplementary Notes can be similarly dependent on not only the Supplementary Notes 1, and 10 to 12, but also various pieces of hardware and software, and various recording devices or systems for recording software without departing from the above-described example embodiments.

When a user transmits a question to generative AI, the generative AI generates an answer to the question.

The answer generated by the generative artificial intelligence (AI) is not appropriate in some cases. Therefore, the user may take time and effort to determine whether the answer by the generative AI is appropriate.

An example of the effect of the present disclosure is that it is possible to easily determine the appropriateness of an answer generated by a generative AI.

1. An answer support apparatus comprising:
one or more memories storing instructions; and
one or more processors configured to execute the instructions to:
receive a user question by a user;
transmit the user question to a plurality of pieces of generative AI and receiving generated answers generated for the user question from a plurality of pieces of the generative AI;
calculate a matching rate of the generated answers by the plurality of pieces of the generative AI;
in a case where the matching rate is equal to or more than a matching rate threshold value, create an output answer based on the generated answers by the plurality of pieces of generative AI;
in a case where the matching rate is lower than the matching rate threshold value, request a different generative AI different from the plurality of pieces of the generative AI that has generated the generated answer among the plurality of pieces of the generative AI for evaluation for each of a plurality of the generated answers, and calculate reliability based on an evaluation result;
in a case where there are the generated answers having the reliability that is equal to or more than the reliability threshold value, create the output answer based on the generated answer having the reliability that is equal to or more than a reliability threshold value;
in a case where there is no generated answer having the reliability that is equal to or more than the reliability threshold value, create the output answer for requesting the user to change the user question; and
output the output answer.

2. The answer support apparatus according to claim 1, wherein the one or more processors are configured to execute the instructions to:
create the output answer indicating a possibility that there are a plurality of answers to the user question, in a case where there are a plurality of the generated answers having the reliability that is equal to or more than the reliability threshold value.

3. The answer support apparatus according to claim 1, wherein the one or more processors are configured to execute the instructions to:
request the generative AI having highest reliability to create the output answer.

4. The answer support apparatus according to claim 1, wherein the one or more processors are further configured to execute the instructions to:
create an alternative question having a possibility of obtaining an appropriate answer to the user question based on the past user question and output answer in a case where the matching rate is lower than the matching rate threshold value; and
create the output answer including the alternative question.

5. The answer support apparatus according to claim 4, wherein the one or more processors are configured to execute the instructions to:
output a screen on which the user is able to select the alternative question to be transmitted to a plurality of pieces of the generative AI from a plurality of alternative questions.

6. The answer support apparatus according to claim 4, wherein
the alternative question is a question capable of specifying a genre from the user question.

7. The answer support apparatus according to claim 4, wherein
the past user question and output answer include the user question and the output answer in a case where the matching rate is equal to or more than the matching rate threshold value, and the user question and the output answer in a case where the reliability is equal to or more than the reliability threshold value.

8. The answer support apparatus according to claim 5, wherein the one or more processors are configured to execute the instructions to:
output a screen on which the selected alternative question is enabled to be edited.

9. The answer support apparatus according to claim 1, wherein the one or more processors are configured to execute the instructions to:
output a screen on which the user is able to select whether to ask an additional question.

10. The answer support apparatus according to claim 4, wherein the one or more processors are configured to execute the instructions to:
output the alternative question to a user to assist the user's decision making on how to rephrase the user question.

11. An answer support method by a computer, the answer support method comprising:
receiving a user question by a user;
transmitting the user question to a plurality of pieces of generative AI and receiving generated answers generated for the user question from a plurality of pieces of the generative AI;
calculating a matching rate of the generated answers by the plurality of pieces of the generative AI;
in a case where the matching rate is equal to or more than a matching rate threshold value, creating an output answer based on the generated answers by the plurality of pieces of generative AI;
in a case where the matching rate is lower than the matching rate threshold value, requesting a different generative AI different from the plurality of pieces of the generative AI that has generated the generated answer among the plurality of pieces of the generative AI for evaluation for each of a plurality of the generated answers, and calculating reliability based on an evaluation result;
in a case where there are the generated answers having the reliability that is equal to or more than the reliability threshold value, creating the output answer based on the generated answer having the reliability that is equal to or more than a reliability threshold value;
in a case where there is no generated answer having the reliability that is equal to or more than the reliability threshold value, creating the output answer for requesting the user to change the user question; and
outputting the output answer.

12. A non-transitory recording medium storing a program for causing a computer to execute processing comprising:
receiving a user question by a user;
transmitting the user question to a plurality of pieces of generative AI and receiving generated answers generated for the user question from a plurality of pieces of the generative AI;
calculating a matching rate of the generated answers by the plurality of pieces of the generative AI;
in a case where the matching rate is equal to or more than a matching rate threshold value, creating an output answer based on the generated answers by the plurality of pieces of generative AI;
in a case where the matching rate is lower than the matching rate threshold value, requesting a different generative AI different from the plurality of pieces of the generative AI that has generated the generated answer among the plurality of pieces of the generative AI for evaluation for each of a plurality of the generated answers, and calculating reliability based on an evaluation result;
in a case where there are the generated answers having the reliability that is equal to or more than the reliability threshold value, creating the output answer based on the generated answer having the reliability that is equal to or more than a reliability threshold value;
in a case where there is no generated answer having the reliability that is equal to or more than the reliability threshold value, creating the output answer for requesting the user to change the user question; and
outputting the output answer.
